(19) United States
(12) Patent Application Publication
(10) Pub. No.: US 2026/0127571 A1
(43) Pub. Date: May 7, 2026

(54) CENTRALIZED ACCOUNT MANAGEMENT AND MESSAGING ROUTING SYSTEM

(71) Applicant: MASTERCARD INTERNATIONAL INCORPORATED, Purchase, NY (US)

(72) Inventors: Ajinkya Sawant, St. Charles, MO (US); Matt Froidl, Saint Louis, MO (US); Robby Gross, Saint Louis, MO (US); Jay Paul Cantwell, O'Fallon, MO (US); Saswata Basu, St. Charles, MO (US)

(21) Appl. No.: 19/438,898

(22) Filed: Jan. 2, 2026

Related U.S. Application Data
(62) Division of application No. 17/496,693, filed on Oct. 7, 2021.
(60) Provisional application No. 63/089,174, filed on Oct. 8, 2020.

(51) Int. Cl. G06Q 20/28; G06Q 20/38; G06Q 20/40; G06Q 30/0207

(52) U.S. Cl. CPC G06Q 20/28; G06Q 20/386; G06Q 20/405; G06Q 30/0215

(57) ABSTRACT

An integrated record management (IRM) computing device is configured to receive and store incentive structures and a record of a credited amount to be credited to a pre-paid debit account associated with a user. The computing device is also configured to receive a first authorization request message for a transaction with a merchant, and compare a transaction amount of the transaction to a credited amount of funds identified in the record. When the transaction amount is greater than the credited amount of funds, the computing device modifies the first authorization request message to generate a second authorization request message and transmits the second authorization request message to an issuer of another payment account associated with the user for authorization processing. When the transaction amount is less than or equal to the credited amount of funds, the computing device initiates a pre-paid debit transaction with the merchant and excluding the issuer.

### CROSS REFERENCE TO RELATED APPLICATIONS

This application is a divisional application from U.S. patent application Ser. No. 17/496,693, filed on Oct. 7, 2021, which claims the benefit of priority to U.S. Provisional Patent Application No. 63/089,174, filed Oct. 8, 2020, each of which is incorporated by reference herein.

### BACKGROUND

This disclosure relates generally to a network-based system for routing messages between parties in a centralized account management system.

Computer networks send messages between multiple nodes within the network. These messages include a variety of data and can be used in many different industries. For example, messages are sent between parties in the financial or payment industry. In the financial industry, many consumers transact frequently or at least periodically with a number of merchants. In a conventional transaction, messages are sent between a merchant, an acquirer, a payment processor, and an issuing bank, to initiate and process payment. These consumers'typical spend across these conventional transactions is somewhat consistent and/or predictable. However, consumers have no way to leverage this predictable spend with the merchant to increase their buying power. Moreover, the merchants cannot access those predictable funds until each purchase transaction is completed.

It would be desirable to enable consumers to extend their purchasing power and provide predictable funds to merchants in advance of the purchase transactions conducted by those consumers. It would be further desirable to manage pre-payment accounts, associated with pre-payments from consumers to merchants, from a centralized system that is able to connect all the parties involved in the transaction, while limiting messaging to non-involved parties. It would also be desirable to integrate this pre-payment management technology into existing payment processing systems so that these new features are easily and seamlessly implementable in the existing payment processing system.

### BRIEF DESCRIPTION

In one embodiment, an integrated record management (IRM) computing device includes a memory and a processor communicatively coupled to the memory. The processor is programmed to store, in the memory, (i) a plurality of incentive structures associated with a respective plurality of merchants, each incentive structure defining a respective incentive to be awarded upon satisfaction of one or more incentive conditions, and (ii) a credit record of a credited amount to be credited to a linked pre-paid debit account associated with a user, the credited amount including a pre-payment amount of funds pre-paid to a first merchant as well as an incentive amount identified in a first incentive structure, wherein the credit record includes a merchant identifier of the merchant and control measures limiting withdrawal of funds in the credited amount from the linked pre-paid debit account to transactions initiated with the merchant. The processor is also programmed to receive a first transaction authorization request message for a purchase transaction initiated by the user with the merchant, the first transaction authorization request message including the merchant identifier of the merchant, a transaction amount, and account identifier of the linked pre-paid debit account; perform a lookup in the memory using the merchant identifier to retrieve the credit record identifying the credited amount of funds available for withdrawal from the linked pre-paid debit account; and compare the transaction amount to the credited amount of funds. The processor is further programmed to, when the transaction amount is greater than the credited amount of funds: (i) modify the first transaction authorization request message to generate a second transaction authorization request message; and (ii) transmit the second transaction authorization request message to an issuer of another payment account associated with the user for authorization processing; and, when the transaction amount is less than or equal to the credited amount of funds, initiate a pre-paid debit transaction with the merchant and excluding the issuer.

In another embodiment, a computer-implemented method is implemented using an integrated record management (IRM) computing device including a memory and a processor communicatively coupled to the memory. The method includes storing, in the memory, (i) a plurality of incentive structures associated with a respective plurality of merchants, each incentive structure defining a respective incentive to be awarded upon satisfaction of one or more incentive conditions, and (ii) a credit record of a credited amount to be credited to a linked pre-paid debit account associated with a user, the credited amount including a pre-payment amount of funds pre-paid to a first merchant as well as an incentive amount identified in a first incentive structure, wherein the credit record includes a merchant identifier of the merchant and control measures limiting withdrawal of funds in the credited amount from the linked pre-paid debit account to transactions initiated with the merchant. The method also includes receiving a first transaction authorization request message for a purchase transaction initiated by the user with the merchant, the first transaction authorization request message including the merchant identifier of the merchant, a transaction amount, and account identifier of the linked pre-paid debit account; performing a lookup in the memory using the merchant identifier to retrieve the credit record identifying the credited amount of funds available for withdrawal from the linked pre-paid debit account; and comparing the transaction amount to the credited amount of funds. The method further includes, when the transaction amount is greater than the credited amount of funds: (i) modifying the first transaction authorization request message to generate a second transaction authorization request message; and (ii) transmitting the second transaction authorization request message to an issuer of another payment account associated with the user for authorization processing; and, when the transaction amount is less than or equal to the credited amount of funds, initiating a pre-paid debit transaction with the merchant and excluding the issuer.

In a further embodiment, an integrated record management (IRM) computing device includes a memory and a processor communicatively coupled to the memory. The processor is programmed to receive, from a plurality of merchant computing devices, a respective plurality of incentive structures defining respective incentives to be awarded upon satisfaction of one or more incentive conditions. The processor is also programmed to store, in the memory, the plurality of incentive structures, and generate a visual representation of at least one of the plurality of incentive structures for display within a user interface of an account management software application stored and executed on a user computing device of a user. The processor is further programmed to receive, from the user computing device, a user selection of a pre-payment transaction associated with a first incentive structure of the plurality of incentive structures, and identify, from the user selection, a merchant identifier, a pre-payment amount, and a pre-payment transaction type of the pre-payment transaction. The processor is also programmed to compare the merchant identifier, pre-payment amount, and pre-payment transaction type to the first incentive structure to determine whether the pre-payment transaction satisfies all incentive conditions of the first incentive structure, and, when the pre-payment transaction satisfies all incentive conditions of the first incentive structure, initiate an electronic transfer of funds equal to the pre-payment amount from a financial account associated with the user to a financial account associated with a merchant identified by the merchant identifier. The processor is still further programmed to store, in the memory, a credit record of a credited amount to be credited to a linked pre-paid debit account associated with the user. The credited amount includes the pre-payment amount as well as an incentive amount identified in the first incentive structure. The credit record includes the merchant identifier and control measures limiting withdrawal of funds in the credited amount from the linked pre-paid debit account to transactions initiated with the merchant.

In another aspect, a computer-implemented method is implemented using an integrated record management (IRM) computing device including a memory and a processor communicatively coupled to the memory. The method includes receiving, from a plurality of merchant computing devices, a respective plurality of incentive structures defining respective incentives to be awarded upon satisfaction of one or more incentive conditions, and storing, in the memory, the plurality of incentive structures. The method also includes generating a visual representation of at least one of the plurality of incentive structures for display within a user interface of an account management software application stored and executed on a user computing device of a user, and receiving, from the user computing device, a user selection of a pre-payment transaction associated with a first incentive structure of the plurality of incentive structures. the method further includes identifying, from the user selection, a merchant identifier, a pre-payment amount, and a pre-payment transaction type of the pre-payment transaction, and comparing the merchant identifier, pre-payment amount, and pre-payment transaction type to the first incentive structure to determine whether the pre-payment transaction satisfies all incentive conditions of the first incentive structure. The method also includes, when the pre-payment transaction satisfies all incentive conditions of the first incentive structure, initiating an electronic transfer of funds equal to the pre-payment amount from a financial account associated with the user to a financial account associated with a merchant identified by the merchant identifier. The method still further includes storing, in the memory, a credit record of a credited amount to be credited to a linked pre-paid debit account associated with the user, the credited amount including the pre-payment amount as well as an incentive amount identified in the first incentive structure, wherein the credit record includes the merchant identifier and control measures limiting withdrawal of funds in the credited amount from the linked pre-paid debit account to transactions initiated with the merchant.

In yet another aspect, at least one non-transitory computer-readable storage media having computer-executable instructions embodied thereon are provided. When executed by at least one processor of an integrated record management (IRM) computing device in communication with a memory, the computer-executable instructions cause the at least one processor to receive, from a plurality of merchant computing devices, a respective plurality of incentive structures defining respective incentives to be awarded upon satisfaction of one or more incentive conditions. The computer-executable instructions also cause the at least one processor to store, in the memory, the plurality of incentive structures, and generate a visual representation of at least one of the plurality of incentive structures for display within a user interface of an account management software application stored and executed on a user computing device of a user. The computer-executable instructions further cause the at least one processor to receive, from the user computing device, a user selection of a pre-payment transaction associated with a first incentive structure of the plurality of incentive structures, and identify, from the user selection, a merchant identifier, a pre-payment amount, and a pre-payment transaction type of the pre-payment transaction. The computer-executable instructions also cause the at least one processor to compare the merchant identifier, pre-payment amount, and pre-payment transaction type to the first incentive structure to determine whether the pre-payment transaction satisfies all incentive conditions of the first incentive structure, and, when the pre-payment transaction satisfies all incentive conditions of the first incentive structure, initiate an electronic transfer of funds equal to the pre-payment amount from a financial account associated with the user to a financial account associated with a merchant identified by the merchant identifier. The computer-executable instructions still further cause the at least one processor to store, in the memory, a credit record of a credited amount to be credited to a linked pre-paid debit account associated with the user. The credited amount includes the pre-payment amount as well as an incentive amount identified in the first incentive structure. The credit record includes the merchant identifier and control measuring limiting withdrawal of funds in the credited amount from the linked pre-paid debit account to transactions initiated with the merchant.

### BRIEF DESCRIPTION OF THE DRAWINGS

FIGS. 1-16 show example embodiments of the methods and systems described herein.

FIG. 1 is a schematic block diagram an example virtual pre-payment management (VPM) computing system in accordance with one example embodiment of the present disclosure.

FIG. 2 is a simplified diagram of an example incentive structure that may be used in the VPM system shown in FIG. 1.

FIG. 3 is a simplified diagram of an example credit record that may be generated by the VPM system shown in FIG. 1.

FIG. 4 illustrates an example configuration of a server system that may be used in the VPM computing system shown in FIG. 1.

FIG. 5 illustrates an example configuration of a client system that may be used in the VPM computing system shown in FIG. 1.

FIGS. 6-10 are example screen-captures of a user interface of an account management software application maintained by the VPM computing system shown in FIG. 1.

FIG. 11 is a flowchart of a computer-implemented method that may be implemented using the VPM computing system shown in FIG. 1.

FIG. 12 depicts a conventional transaction processing flow.

FIG. 13 illustrates a pre-paid debit transaction processing flow using the VPM system shown in FIG. 1.

FIGS. 14A and 14B illustrate a modified transaction processing flow using the VPM system shown in FIG. 1.

FIGS. 15A and 15B illustrate a hybrid transaction processing flow using the VPM system shown in FIG. 1.

FIG. 16 is a flowchart of another computer-implemented method that may be implemented using the VPM computing system shown in FIG. 1.

### DETAILED DESCRIPTION

The following detailed description illustrates embodiments of the disclosure by way of example and not by way of limitation. The description enables one skilled in the art to make and use the disclosure, describes several embodiments, adaptations, variations, alternatives, and uses of the disclosure, including what is presently believed to be the best mode of carrying out the disclosure. The disclosure is described as applied to an example embodiment, namely, systems and methods for centralized message routing and pre-payment management across multiple merchants for a user within a centralized computer-based platform.

Embodiments of the present disclosure describe a virtual pre-payment management (VPM) computing system, and methods implemented using such a computing system. The VPM computing system is configured to centralize and manage users'pre-payment to merchants, and to offer users a centralized platform at which users can purchase credit or otherwise pre-pay various amounts to a plurality of merchants, in exchange for incentives for their pre-payment. Users may track their spending or transaction history with these merchants (and/or other merchants), review a credited amount remaining for each of the merchants, review their accumulated incentives, make additional pre-payments, and search for additional merchants to pre-pay in exchange for incentives. All of these pre-payments and associated credits (including awarded incentives) are linked to a single payment account, referred to as a linked pre-paid debit account, which provides efficiency in transaction monitoring and usage (e.g., debiting) of the pre-paid credits and increases the ease of use by the user (e.g., avoiding the need for multiple accounts and/or payment cards to access the credited funds). The linked pre-paid debit account is configured to be used (i) as a regular payment account where payment messages (e.g., ISO 8583 network authorization messages, etc.) are exchanged between multiple parties associated with a transaction, (ii) as a pre-paid account where a purchase being made is less than or equal to a pre-paid amount stored in the centralized VPM computing system and the messaging is altered as explained further herein, and (iii) as a hybrid payment card, where a transaction is paid partly using funds in the pre-paid debit account and partly with a regular payment transaction to pay the difference, and the transaction messages are altered accordingly, as explained further herein.

The VPM computing system is configured to generate the linked pre-paid debit account, monitor transactions associated with that pre-paid debit account and one or more other payment accounts associated with the user, and to maintain a centralized record database. Because all of the functions and features are integrated into a centralized computing system, a computing device (e.g., server computing device) of the VPM computing system may be generally referred to as an integrated record management (IRM) computing device. It should be readily understood that any functionality described herein as being performed by the IRM computing device may be performed by a plurality of computing devices of the VPM computing system or by a single computing device.

The IRM computing device is configured to maintain an account management platform, accessible to users of the VPM computing system using a respective user computing device (e.g., a smartphone, laptop computer, desktop computer, tablet, etc.). The account management platform is accessible, for example, over a website and/or a software application stored and/or executed on the user computing device—collectively referred to herein as an account management app.

For example, the account management platform is accessible by a merchant, to input incentive structures and associated rules for offers and incentives, as well as by users to initiate pre-payment to one or more such merchants according to those rules. The account management platform is further accessible by users to review their transaction history across a period of time, to determine whether particular offered incentives are desirable.

Specifically, the account management app enables a user to review and select or purchase incentives offered by various merchants for pre-paying the merchants or pre-funding a virtual debit card (i.e., the linked pre-paid debit account) with credits useable at the merchant. Various phrases may be used herein to refer to this “pre-payment” of merchants in exchange for incentives, including, for example, pre-paying for or purchasing merchant credits, pre-funding a virtual debit card or account, and pre-payment of funds at or for participating merchants. The pre-paid debit account has payment credentials associated therewith that mirror payment credentials for a typical debit or pre-paid card, such as a 16-digit PAN, expiration date, and security code. Using the payment credentials for the pre-paid debit account (e.g., via manual entry or the use of a digital wallet) enables the user to access and use their pre-paid funds stored in the pre-paid debit account. As described further herein, these payment credentials can function as a pre-paid debit account but also can function to initiate hybrid (e.g., partially pre-paid) transactions.

In the example embodiment, the IRM computing device is communicatively coupled to a plurality of merchant computing devices, each merchant computing device associated with a merchant that offers incentives for pre-payment (“participating merchant”). Each participating merchant controls their own incentive offerings. Various incentive offerings may include immediate “cash-back” upon pre-payment (e.g., receive 10% cash back or a 10% additional credited amount, or receive $X cash-back), coupons (e.g., get an additional 10% off all payments), or other offerings.

In some cases, participating merchants may offer graduated incentives that are based on an amount and/or frequency of pre-payment. For example, a merchant may offer a 10% credit on all pre-payments greater than $200, but only 5% credit on pre-payment less than $200. As another example, a merchant may offer a 10% credit on recurring pre-payments (of any amount, or above a threshold amount), and a 5% credit on a one-time pre-payment (of any amount, or above a threshold amount). Incentives may also be variable based on other factors, for example, but not limited to, a transaction history with a particular customer, a time of year (e.g., greater incentives around a holiday shopping season), location, demographics, or a particular marketing campaign (e.g., offering greater incentives to customers in a particular spending band).

The IRM computing device receives the various incentives being offered by participating merchants as a data structure referred to as an “incentive structure.” The incentive structure includes incentive rules or conditions that must be satisfied to receive an incentive, broadly referred to as “incentive amount.” The incentive conditions may be embodied as an array of data elements or a table, for example. The incentive structure includes data elements defining each of the incentives offered by the participating merchant and the incentive conditions associated therewith. The data elements may include, for example, the incentive amount (which may be a discrete value or percentage, and/or may include discounts, coupons, etc.), one or more thresholds (e.g., a minimum pre-payment amount to receive a particular incentive amount), a payment type condition (e.g., one-time vs. recurring), an active date range for the incentive, and/or any limiting factors (e.g., only provide this to users with a purchase history spanning more than a year with the merchant, or users that have spent more than $1,000 within a year, etc.).

The incentive structure also includes a merchant identifier that associates the incentives being offered with the particular participating merchant. The merchant identifier may be a merchant name, an alphanumeric code identifying the merchant, and/or any other merchant identifier. In some embodiments, the merchant identifier may include multiple variations that all apply to the same merchant (e.g., “MerchantName.com” as well as “Merchant Name” for brick-and-mortar locations; merchant identifiers associated with different branches of the same merchant; and the like). The IRM computing device stores the incentive structures in a database or memory, which may be integral to the IRM computing device or a separate database or memory communicatively coupled to the IRM computing device.

The IRM computing device is configured to generate a visual representation of one or more of the stored incentive structures for display to a user within the user interface of the account management app (e.g., as stored and/or executed on their user computing device). The visual representation may include text, images, charts (e.g., pie charts, bar charts, line graphs, etc.), and the like. The visual representation may also include ranking or sorting the incentive structures prior to display (e.g., alphabetically, in order of value of the incentive offered, by merchant category, etc.), as well as comparisons of incentive structures (e.g., between merchants in a same merchant category).

The IRM computing device may display any number of visual representations of incentive structures. In some embodiments, the IRM computing device receives, from the user computing device, a user search inquiry including a merchant name or merchant category. The IRM computing device may identify participating merchants associated with the user search inquiry and display the incentives for those merchants in response thereto.

In some embodiments, the IRM computing device leverages a user's previous transaction history to determine which incentives to display. The transaction history includes transaction data for a plurality of transactions initiated by the user with a plurality of merchants over a period of time (e.g., the past six months, the past year, the past two years, etc.). Specifically, the IRM computing device may access the transaction history from a transaction database and/or may request or receive the transaction history from a payment processor. The transaction history includes purchase transactions made by the user using one or more payment accounts and/or payment cards associated therewith. That is, the transaction history is not necessarily limited to one payment account and/or payment card.

The IRM computing device is configured to analyze the transaction history to make recommendations to a user, such as which merchants to pre-pay in return for incentives. The IRM computing device analyzes the transaction history as well as the stored incentive structures to determine correlations therebetween, and generates recommendations based on those correlations.

In some embodiments, the IRM computing device is configured to identify, based on the transaction history, a subset of merchants with which the user regularly or frequently transacts. These merchants may include merchants at which the user has transacted multiple times per month (or other interval or time) or at regular intervals (e.g., every week, month, etc.). The IRM computing device may then perform a lookup in the database (e.g., using merchant identifiers of the subset of merchants) to identify any incentive(s) offered by these merchants, and display those incentives offered. Specifically, by identifying this subset of merchants and providing incentives to the user to pre-pay these merchants, the user's money is maximized. The user is known to already transact regularly with these merchants, so the incentive being offered is more likely to appeal to the user, and the user receives the benefit of the incentive for pre-paying these merchants.

In some such embodiments, the IRM computing device is also configured to compute or calculate an average monthly spend, by the user, at each of the merchants in the subset. For example, the IRM computing device may parse or divide the transaction data based on the merchant identifiers into merchant-level transaction data, and further divide the merchant-level transaction data into month-long intervals (e.g., using a date/time of each transaction). The IRM computing device may then calculate the average monthly spend of the user at each of these merchants. Based on the average monthly spend, the IRM computing device may perform a lookup in the database (e.g., using merchant identifiers of the subset of merchants and/or the average monthly spend at each merchant) to identify any incentive(s) offered by these merchants. More specifically, the IRM computing device retrieves the maximum incentive offered by each merchant, based on the average monthly spend.

Additionally or alternatively, the IRM computing device may generate an incentive structure matching or proportional to the user's average monthly spend at each of these merchants. For example, where a user spends $800 monthly at one merchant, but the only incentives are offered for $500 (e.g., with an 8% incentive credit) and for $1000 (e.g., with a 10% incentive credit), the IRM computing device may generate an incentive structure for $800 (e.g., with a 9% incentive credit). The IRM computing device may generate such an incentive structure as a conditional incentive structure, and may transmit a confirmation request message to the associated merchant requesting confirmation therefrom that the merchant will honor this incentive. Moreover, in some embodiments, the IRM computing device may recommend incentive structures (e.g., based on one or more user's average monthly spend) to merchants prior to offering those incentives to the user.

The IRM computing device displays these incentives, to encourage the user to pre-pay the merchant for their average monthly spend in exchange for the incentive. The money the user is known to regularly spend at these merchants can then be maximized, based on the incentive offered. In particular, in any of these embodiments, the merchant may offer a greater incentive for recurring payments (e.g., recurring payments in an amount approximating the user's average monthly spend), thereby rewarding the user for pre-committing their monthly spend to the merchant each month.

In some embodiments, the IRM computing device may be further configured to identify and display incentives offered for “competitor merchants,” or merchants in the same merchant category as the subset of merchants (e.g., the merchants with which the user regularly transacts). These merchants may present more competitive incentives in an attempt to capture at least a portion of the user's spend. In these embodiments, the IRM computing device may be configured to identify competitor merchants based on the merchant category (e.g., a merchant category code) for the subset of merchants and/or a merchant name or identifier in a user search inquiry, retrieve the incentive structures for the competitor merchants, and generate the visual representation of the incentives offered by the competitor merchants as well as the subset of merchants and/or merchants that are the subject of a user search inquiry. Additionally, where a user regularly transacts at a merchant that is not offering any incentive (e.g., is not a participating merchant), the IRM computing device may identify a similar competitor merchant, such as a participating merchant with a same merchant category code (MCC), and recommend that the user shift their spend to the similar competitor merchant, to earn the additional benefits offered through an incentive structure with the similar competitor merchant.

The user may access the account management app using their user computing device, to view the visual representation of the incentive structures, representing the incentives offered by participating merchants for pre-paying those merchants. The user may also search for participating merchants and/or merchant categories to view any incentive(s) offered thereby. In addition, the user may review their transaction histories, subsets of merchants with which they frequently transact, and their spend thereat (including the raw spend at these merchants and/or the average monthly spend). The user may also use the account management app to manage access to their transaction history, such as opting in to providing their transaction history to the IRM computing device, adding or removing payment accounts and/or associated cards for transaction and spend monitoring, and/or opting out.

In some embodiments, the account management app may provide various user controls that enable the user to control which incentives are displayed and/or how those incentives are displayed. In addition to the search controls described above, which may be embodied as a fillable text field, the account management app may provide sorting, filtering, ranking, and/or other tools. For example, a ranking tool, when selected by the user, may enable the user to rank the displayed incentives (e.g., by the highest absolute offer, the greatest ratio of incentive to pre-payment amount, etc.). As another example, a sorting tool, when selected by the user, may enable the user to sort the displayed incentives according to other incentive conditions or other elements of the incentive structure (e.g., soonest to expire, newest offers, etc.).

When the user identifies an incentive they wish to receive (i.e., by pre-paying the merchant according to the incentive conditions), the user selects the incentive within the user interface of the account management app. The user may tap, click, or otherwise select a visual representation of the selected incentive. In some embodiments, the account management app may display one or more dialog boxes to the user, asking for additional information and/or confirmation of their selection. In the example embodiment, the user provides a pre-payment amount and a pre-payment transaction type (e.g., one-time or recurring). The user-selected incentive and any user-provided information is formatted as a pre-payment transaction message (e.g., by the account management app) and transmitted to the IRM computing device.

The IRM computing device receives the user selection as represented by the pre-payment transaction message. The pre-payment transaction message includes data elements such as a merchant associated with the selected incentive (e.g., a merchant name, merchant identifier, etc.), the pre-payment amount, and the pre-payment transaction type. The pre-payment transaction message may also include an identifier of the specific incentive selected by the user, for example, where a merchant has multiple active incentive structures.

In the example embodiment, the IRM computing device identifies the user-selected incentive based on data in the pre-payment transaction message and retrieves the associated incentive structure from the database. The IRM computing device compares the data in the pre-payment transaction message with the incentive structure to determine whether the pre-payment transaction satisfies all of the incentive conditions of the incentive structure and, therefore, the user is eligible to receive the incentive offered in the incentive structure. In particular, the IRM computing device compares the merchant, pre-payment amount, and pre-payment transaction type to the first incentive structure to determine whether the pre-payment transaction satisfies all incentive conditions of the first incentive structure. In some embodiments, a user selects a one-time pre-payment time but is otherwise eligible for an incentive associated a recurring pre-payment type, which may have a greater associated incentive amount. The IRM computing device may display a prompt to the user, including a prompt for the user to select the corresponding recurring pre-payment type in exchange for the greater incentive amount.

When all of the incentive conditions are satisfied, the IRM computing device is configured to initiate a transfer of funds in the pre-payment amount from a financial account associated with the user to a financial account associated with the merchant. The IRM computing device may initiate the transfer, for example, by transmitting instructions (e.g., over the payment processing network, an ACH network, etc.) to the issuer of the user's financial account to transmit the funds in the pre-payment amount to the financial account associated with the merchant. This transfer may be implemented as a typical payment transaction, processed over a payment processing network with a series of network messages (e.g., ISO 8583 network authorization messages) between the issuing bank associated with a user's (funding) payment account, an acquirer associated with the financial account of the merchant, and the merchant.

In some cases, the financial account associated with the merchant is a financial account from which the merchant can make withdrawals as desired. In other cases, the financial account associated with the merchant is a holding account maintained at a third-party financial institution, and funds from the holding account are only made available to the merchant when the user actually makes a purchase with the merchant, as described further herein.

The IRM computing device also generates a credit record associated with the pre-payment transaction and stores the credit record in the centralized database. The credit record serves as a record that the user has pre-paid the merchant in the pre-payment amount and has received an incentive in exchange. Therefore, the user has “credits” in an amount equal to the sum of the pre-payment amount and the incentive amount. Notably, as described above, the “incentive amount” may refer to a specific amount of funds, based on the pre-payment amount and the specific incentive offered, but may alternatively include discounts or coupons to be applied to future purchases. In such cases, the credits are in the pre-payment amount, and the credit record includes additional data elements identifying the discounts or coupons to be applied (such that the discounts or coupons will be applied, as available, to one or more qualifying future purchases). The credits (which include credits in a monetary value as well as any other incentives) are stored in the linked pre-paid debit account and are available to apply to future purchases with that merchant. The user may access and use these funds by initiating purchase transactions using the payment credentials for the linked pre-paid debit account.

The credit record includes the credited amount, as well as an identifier of the user, the user's pre-paid debit account, and/or the user's payment account used to initiate the pre-payment transaction. The credit record also includes an identifier of the merchant and/or other control measures that limit withdrawal of funds in the credited amount from the linked pre-paid debit account to transactions initiated with that merchant. These control measures may include the merchant identifier itself, such that any withdrawal request (e.g., a transaction authorization request message) must include the merchant identifier for the credited amount to be applied. Other control measures may include verification or authentication rules associated with the merchant and/or the user.

The IRM computing device may store any number of credit records for the user, each credit record detailing a separate pre-payment transaction, the incentives received, and the credited amount added to the user's pre-paid debit account but limited to withdrawals to transactions initiated with the corresponding participating merchant. Additionally or alternatively, the IRM computing device may modify, update, or delete credit records in response to subsequent pre-payment transactions (which increase the credited amount available for payment of transactions with associated merchants) and/or purchase transactions (which decrease the credit amount, as described further herein). An overall credited amount available to the user in the pre-paid debit account may be displayed to the user within the user interface of the account management app, as well as the individual credited amount(s) associated with each of a plurality of merchants that the user has pre-paid.

In embodiments where the user has selected an incentive based on recurring pre-payment transactions, the IRM computing device may be configured to initiate subsequent pre-payment transactions at the interval agreed to by the user. For example, a user selected a pre-payment incentive based on monthly pre-payment transactions of a particular pre-payment amount. After a month has elapsed from the first pre-payment transaction, the IRM computing device may initiate a second transfer of funds in the same pre-payment amount from the financial account associated with the user to the financial account associated with the merchant. The IRM computing device may further generate a new credit record associated with this second pre-payment transaction and/or update, in the centralized database, the existing credit record with an updated credited amount, by adding the pre-payment amount and the incentive amount to any remaining credited amount in the linked pre-paid debit account. The user may access the account management platform to manage any recurring payments, such as adjusting a recurring payment amount, adjusting a recurring payment frequency, or cancelling a recurring payment.

As described above, the credited, pre-paid funds are available for the user to use during purchase transactions with the merchant(s) that the user has pre-paid. The user may access these funds using their digital wallet or virtual pre-paid debit card (e.g., payment credentials such as a PAN associated with the linked pre-paid debit account) to initiate a purchase transaction with the merchant. Additionally or alternatively, the user may have and use a physical pre-paid debit card (e.g., including the payment credentials associated with the linked pre-paid debit account) to initiate a purchase transaction with the merchant. These payment credentials, associated with the linked pre-paid debit account, may be used to initiate one or more of pre-paid debit transactions, hybrid pre-paid/real-time transactions, and modified purchase transactions, as described further herein.

Upon initiation of the purchase transaction, the merchant transmits a first transaction authorization request message requesting authorization of the purchase transaction. The first transaction authorization request message is formatted as an ISO 8583 network authorization message, and includes the payment credentials of the linked pre-paid debit account as well as a total transaction amount. The first transaction authorization request message is processed over a payment processing network. In some embodiments, the IRM computing device may be associated with and/or integral to the payment processing network, and receives the first transaction authorization request message directly. In the example embodiment, the payment credentials identify the purchase transaction as being initiated using a linked pre-paid debit account. For example, a BIN (or a number of leading digits of the payment credentials) may be associated with VPM computing system and, as such, is known to be initiated using a linked pre-paid debit account. The BIN causes the payment processing network, over which network messages including PANs including the BIN are processed, to route the network messages including the BIN to the IRM computing device.

The IRM computing device receives the first transaction authorization request message, which includes the payment credentials, such as an account identifier, of the linked pre-paid debit account, a merchant identifier of the merchant with which the transaction was initiated, and the total transaction amount (e.g., a purchase amount). The IRM computing device first uses the account identifier to perform a lookup in the centralized database, to retrieve all credit records associated with the linked pre-paid debit account. The IRM computing device also performs a lookup in the database using the merchant identifier, which filters the retrieved credit records to only the credit record(s) associated with that merchant. The lookup operation therefore, when successful, returns one or more credit records identifying the credited amount of funds pre-paid to that merchant and available for withdrawal from the linked pre-paid debit account.

Where any coupons or discounts are identified in the credit record, the IRM computing device determines whether those coupons or discounts are applicable to the purchase transaction. The IRM computing device may compare stored terms of the coupons and discounts (e.g., minimum purchase thresholds, required items to be purchased, etc.) to data received in the first transaction authorization request message. If the coupons or discounts are applicable, the IRM computing device applies the coupons or discounts to the purchase transaction. More specifically, the IRM computing device adjusts the total transaction amount before deducting the (adjusted) transaction amount from the credited amount, as described further herein.

In some instances, the total transaction amount (or the adjusted transaction amount, where any discounts or coupons are applied) is less that a total credited amount of funds identified in the corresponding credit record. That is, the purchase transaction can be completed paid for using credited/pre-paid funds. In such instances, the IRM computing device updates the corresponding credit record, and generates a substitute authorization response message for transmission back to the merchant, without the first transaction authorization request message being transmitted to an issuer (or any other downstream party). The IRM computing device may be authorized and configured to generate the substitute authorization response message independently, or may be configured to transmit instructions to the payment processor or another component of the VPM computing system to generate and transmit the substitute authorization response message. The substitute authorization response message is formatted as a network message (e.g., an ISO 8583 network authorization message) and transmitted back to the merchant/acquirer. The merchant/acquirer process the substitute authorization response message as normal. In these instances, the IRM computing device facilitates reduced messaging across the conventional payment processing network, by intercepting the first transaction authorization request message and, when the total transaction amount is fully covered by the credited amount of funds in the linked pre-paid debit account, generating and transmitting the substitute transaction authorization response message without further downstream messaging (e.g., to/from an issuer computing device). This transaction processing may be referred to generally as pre-paid debit transaction processing.

In other instances, the linked pre-paid debit account has no available funds to be applied to the purchase transaction. For example, the user may use the payment credentials associated with the linked pre-paid debit account, but may have not pre-paid that particular merchant, or may have already used all available credited funds. In such cases, the IRM computing device determines whether the user has identified any other payment account to be used when credited funds are unavailable. For example, the user may use the account management platform to identify a traditional payment account (e.g., credit or debit account) to make initial pre-payment transactions. The user may select an option to have this account made available to conduct purchase transactions that are initiated with the payment credentials of the linked pre-paid debit account, but where credited funds are insufficient to cover a total transaction amount. That is, the user may identify one traditional payment account as a supplemental payment account.

If the user has made such a selection and identification of the supplemental payment account, the IRM computing device is configured to generate a modified transaction authorization request message. The modified transaction authorization request message is formatted as a network message (e.g., an ISO 8583 network authorization message), and includes the total transaction amount, the merchant identifier, and other information from the first transaction authorization request message. However, the IRM computing device replaces the payment credentials associated with the linked pre-paid debit account with the payment credentials of the supplemental payment account, to generate the modified transaction authorization request message. The modified transaction authorization request message is then transmitted over the payment network to the issuer computing device (of the issuer of the supplemental payment account) for authorization processing.

The IRM computing device may store a record of any such modifications, the modification record including the payment credentials of the linked pre-paid debit account, used to initiate the transaction, and the replacement payment credentials of the supplemental payment account. The modification record may include additional data elements, such as some identifier of the transaction, the transaction amount, the merchant identifier, and the like. The IRM computing device stores the modification record in an internal memory and/or in the centralized database.

The IRM computing device may also add one or more data elements to the modified transaction authorization request message before the modified transaction authorization request message is transmitted to the issuer, including a modification flag. The modification flag identifies the corresponding transaction as modified by the IRM computing device, and, upon processing by the issuer computing device, causes the issuer computing device to append the modification flag to any subsequent, first transaction authorization response message (e.g., an approval or decline transaction authorization response message). When the first transaction authorization response message is processed over the payment network, the modification flag causes the first transaction authorization response message to be intercepted again by the IRM computing device. The IRM computing device interprets the modification flag, parses data (e.g., the payment credentials of the supplemental payment account, a transaction identifier, etc.) from the first transaction authorization response message, and uses that parsed data to query the memory/centralized database for a corresponding modification record.

The IRM computing device uses the retrieved modification record to modify the first transaction authorization response message and generate a modified transaction authorization response message (or, as described above, cause the payment processor or another component of the VPM computing system to generate the modified transaction authorization response message). Specifically, the IRM computing device replaces the payment credentials of the supplemental payment account with the payment credentials of the linked pre-paid debit account used to initiate the purchase transaction. In this way, the modified transaction authorization response message is transmitted back to the acquirer/merchant, and those parties can readily match the modified transaction authorization response message to the first transaction authorization request message, and can process the modified transaction authorization response message as normal - that is, without any knowledge of the use of the supplemental payment account. This transaction processing, with the IRM as an intermediate “credential switching” device, may be generally referred to as modified transaction processing, with corresponding transactions being referred to as modified purchase transactions.

In still other instances, the credited amount of funds in the linked pre-paid debit account only covers a portion of the total transaction amount. In these cases, the IRM computing device may perform hybrid transaction processing, which is a hybrid between the modified transaction processing and the pre-paid debit transaction processing, both of which are described above. Specifically, the first transaction authorization request message is intercepted by the IRM computing device, based on the payment credentials of the linked pre-paid debit account (e.g., based on a BIN of a PAN that causes routing of network messages having that BIN to the IRM computing device).

The IRM computing device compares the total transaction amount to the credited amount of funds in the linked pre-paid debit account that are available to credit to purchases with the merchant identified using the merchant identifier in the first transaction authorization request message. The IRM computing device applies all available credited funds to the total transaction amount (as well as any applicable coupons/discounts, as described above) and determines a pre-paid amount and an adjusted transaction amount. The adjusted transaction amount is the total transaction amount, less the pre-paid amount, which includes the credited funds (and any applicable coupons/discounts). The IRM computing device initiates a pre-paid debit transaction, as described above, in the pre-paid amount. The IRM computing device also generates a hybrid transaction authorization request message, which is formatted as a network message (e.g., an ISO 8583 network authorization message). The IRM computing device replaces (i) the total transaction amount with the adjusted transaction amount, and (ii) the payment credentials of the linked pre-paid debit account with the payment credentials of the supplemental payment account, to generate the hybrid transaction authorization request message (or, as described above, cause the payment processor or another component of the VPM computing system to generate the hybrid transaction authorization request message). The IRM computing device also appends a hybrid flag (which may be formatted similarly to the modification flag described above) to the hybrid transaction authorization request message. The hybrid flag causes the issuer computing device to also append the hybrid flag to any subsequent authorization response, and causes any such authorization response to be routed back to the IRM computing device.

The IRM computing device may further generate a modification record, as described above. The modification record includes the payment credentials of the linked pre-paid debit account used to initiate the transaction, the (replacement) payment credentials of the supplemental payment account, the (original) total transaction amount, and the adjusted transaction amount. The modification record and/or the hybrid transaction authorization request message may include additional data elements that may be efficacious in implementing the hybrid transaction processing.

The IRM computing device (or payment processor) transmits the hybrid authorization request message to the issuer computing device (of the issuer of the supplemental payment account) for authorization processing. The issuer computing device transmits a first transaction authorization response message, including the hybrid flag, for processing over the payment processing network. The hybrid flag causes the first transaction authorization response message be routed to/intercepted by the IRM computing device. The IRM computing device interprets the hybrid flag, parses data (e.g., the payment credentials of the supplemental payment account, a transaction identifier, etc.) from the first transaction authorization response message, and uses that parsed data to query the memory/centralized database for a corresponding modification record.

The IRM computing device uses the retrieved modification record to modify the first transaction authorization response message and generate a hybrid transaction authorization response message (or, as described above, cause the payment processor or another component of the VPM computing system to generate the hybrid transaction authorization response message). Specifically, the IRM computing device replaces the payment credentials of the supplemental payment account with the payment credentials of the linked pre-paid debit account used to initiate the purchase transaction. The IRM computing device also replaces the adjusted transaction amount with the (original) total transaction amount. In this way, the hybrid transaction authorization response message is transmitted back to the acquirer/merchant, and those parties can readily match the hybrid transaction authorization response message to the first transaction authorization request message, and can process the hybrid transaction authorization response message as normal - that is, without any knowledge of the use of the supplemental payment account.

The IRM computing device stores any additional records necessary to facilitate subsequent “hybrid” clearing and settlement of the transaction, which includes typical transfer of funds in the adjustment transaction amount between the issuer and the acquirer, as well as any applicable “release” of pre-paid funds to the merchant.

In some cases, where the user initiates the purchase transaction with a total transaction amount that exceeds the credited amount of funds available for use with that merchant, the IRM computing device is configured to identify whether the merchant has any active incentives that may be offered to the user, such that the user may replenish their credited funds with the merchant. The IRM computing device may perform a lookup in the database using the merchant identifier to retrieve any incentive structures associated with the merchant. If any incentives are available—as represented by any retrieved incentive structures—the IRM computing device may display those incentives to the user, for example, in a dialog box on their user computing device. For example, the dialog box may read: “This purchase exceeds the amount of funds you have available with MERCHANT A. MERCHANT A is offering INCENTIVE X—would you like to purchase INCENTIVE X and have those funds applied to the current purchase?” The user may accept and the above-described process for purchasing an incentive (i.e., pre-paying a merchant) and crediting funds to the user may be implemented. The IRM computing device may then apply the newly credited funds to the current purchase transaction according to the above-described pre-paid debit transaction processing.

In some other embodiments, such as where the user has not identified any supplemental payment account, the IRM computing device may intercept the first transaction authorization request message and, without transmitting the first transaction authorization request message to any issuer computing device, generate a decline response message for transmittal back to the merchant. Alternatively, the IRM computing device may, in real-time during processing of the transaction, prompt the user (e.g., via messaging over a network other than the payment network, such as via the internet or text message) to enter alternative payment credentials to cover the remaining, adjusted amount of the purchase transaction. For example, the IRM computing device may display a dialog box to the user that reads: “After applying your credited funds, your total is $10.00 for this purchase. Please select an alternative payment method to complete the transaction.” The IRM computing device may then generate the hybrid transaction authorization request message as described above, with any payment credentials input in real-time by the user, to be processed over the payment processing network as normal that is, to be sent to an issuer of those payment credentials.

Where credited funds, coupons, or discounts are fully expended in any transaction, the IRM computing device may update the credit record to remove details of the stored coupons or discounts. Otherwise, the IRM computing device may update the credit record to reflect usage of (but not full depletion of) the funds, coupons, or discounts.

In other embodiments, if the user has not pre-paid that merchant or has depleted their pre-paid funds, the lookup operation may return an error or a null record, indicating that no credited funds are available to be applied to the purchase transaction.

Therefore, the IRM computing device requires minimal data to retrieve and apply credited or pre-paid funds in real-time during processing of the purchase transaction (e.g., without substantial delay in processing). More specifically, the particular structure of the credit record, which includes the account identifier and merchant identifier(s) applicable credit funds stored in the pre-paid debit account, enables rapid retrieval of the information therein. In the example embodiment, only the account identifier, merchant identifier, and transaction amount from the transaction authorization request message are required - the account and merchant identifiers enable rapid retrieval of the relevant credit record, comparison of the transaction amount and the credited amount in the retrieved record enable rapid application of credited funds to a purchase transaction, and, where applicable, rapid retrieval of any payment credentials of a supplemental payment account for real-time transaction processing.

In at least some embodiments, where the user has a credited amount of funds greater than or equal to the transaction amount that are available to be applied to the purchase transaction, the IRM computing device is configured to perform the above-described pre-paid debit transaction processing (with reduced messaging over the payment processing network) and deduct the transaction amount from the credited amount of funds. In the example embodiment, the actual value of the pre-paid funds has already been withdrawn from a financial account of the user and transferred to a financial account associated with the merchant. Therefore, the deduction process implemented by the IRM computing device involves no transfer of money but rather record generation and maintenance, to track the use of the funds already pre-paid by and credited to the user. Specifically, the IRM computing device is configured to generate a transaction record associated with the purchase transaction, and store the transaction record in the database, in a memory location associated with the credit record, to track withdrawals of portions or all of the credited amount of funds from the linked pre-paid debit account. The transaction record includes a record of the purchase transaction, the transaction amount deducted from the credit amount, and any other information associated with the deduction. In some cases, the transaction record is a new file generated and saved by the IRM computing device; in other cases, the transaction record represents an update or modification to the credit record. The updated credited amount of funds available in the pre-paid debit account is reflected to the user, for example, within their account management app.

In other embodiments of the present disclosure, the value of the pre-paid funds has been withdrawn from the financial account of the user and transferred to a third-party holding account. That is, the funds have not actually been provided to the merchant. In such embodiments, when the purchase transaction is approved according to the pre-paid debit transaction processing described above, the IRM computing device transmits an instruction to the third-party financial institution to transmit funds in a value proportional to the transaction amount from the holding account associated with the merchant to a financial account of the merchant where the funds are readily available to the merchant without restriction. The full transaction amount may not be transferred, because the purchase transaction is partially completed with incentive funds. That is, in many cases, the user did not pay - from their own financial account - the full credited amount, and therefore the merchant is paid for the purchase transaction in an amount proportional to the user's pre-payment. For example, where a user pre-paid $1,000 to receive a $100 incentive credit (i.e., a 10% incentive credit), only $1,000 would have been withdrawn from the user's financial account and transferred to the holding account. Where the user makes a purchase transaction with a transaction amount of $400.00, the merchant may only receive $390.00 (i.e., $400.00 minus the 10% incentive amount) from the holding account.

In some embodiments of the present disclosure, a user may wish to retrieve the funds that were pre-paid to a merchant (e.g., where the user no longer intends to transaction with that merchant). In some embodiments, all actual funds original pre-paid to the merchant may be returned to the user—that is, the user does not receive any funds associated with the incentive. In other embodiments, a lesser amount of funds is returned to the user (e.g., 90% of their original pre-paid value, or an amount of funds proportional to the original amount, less the value of any discounts or coupons applied to previous purchases, where those coupons or discounts were an incentive offered for the pre-payment of the merchant).

In some embodiments, the VPM computing system is associated with or integral to a payment processing network, such that the VPM computing system may leverage existing relationships between merchants and the payment processing network, and may conduct pre-payment transactions (e.g., debit and/or credit transactions) over the payment processing network. In other embodiments, the VPM computing system is separate from but in communication with such a payment processing network.

Although reference is made herein to a “virtual debit card,” the same pre-funding functionality is applicable in the same way to an account associated with a physical debit card. In some embodiments, both a virtual debit card (e.g., stored in a digital wallet) and a physical debit card may be linked to the same account used to pre-pay for merchant credits, and both the virtual debit card and the physical debit card may be used to initiate transactions with the merchant to spend the merchant credits. As used herein, the terms “payment card,” “transaction card,” and “financial transaction card” refer to any suitable payment card, such as a credit card, a debit card, a prepaid card, a charge card, a membership card, a promotional card, a frequent flyer card, an identification card, a prepaid card, a gift card, and/or any other payment device that may hold payment account information, such as mobile phones, smartphones, personal digital assistants (PDAs), key fobs, and/or computers. Each type of payment device can be used as a method of payment for performing a transaction.

The technical problems addressed by the present disclosure include: (a) existing limitations in pre-paying merchants, specifically that limit users to seeking out and purchasing pre-payments separately with each individual merchant, (b) the need for multiple individual pre-paid cards or accounts for separate merchant purchases, (c) lack of optimal purchasing power for users that frequent the same merchants, (d) inability of merchants to access funds prior to purchases being made despite the relative certainty of eventually receiving those funds, and (e) inability of users to initiate transactions in amounts exceeding a pre-paid, credited amount with a merchant.

The technical solutions provided by the present disclosure include: (a) enabling pre-payment purchases with multiple merchants within a same environment, (b) centralization of merchant pre-payment, incentive provision, and purchase tracking, (c) tracking user's actual spend to recommend incentives and optimize user's purchasing power, (d) new and improved electronic data structures to track incentives, pre-payments, and withdrawals from credited funds, (e) enabling merchants to access funds prior to expected purchases being conducted, (f) enabling use of a same set of payment credentials to apply credited funds across many merchants, and (g) enabling use of the same set of payment credentials to initiate pre-paid debit transactions, modified transactions, and hybrid transactions.

These technical solutions may be achieved by performing at least one of the following steps: (a) storing, in the memory, (i) a plurality of incentive structures associated with a respective plurality of merchants, each incentive structure defining a respective incentive to be awarded upon satisfaction of one or more incentive conditions, and (ii) a credit record of a credited amount to be credited to a linked pre-paid debit account associated with a user, the credited amount including a pre-payment amount of funds pre-paid to a first merchant as well as an incentive amount identified in a first incentive structure, wherein the credit record includes a merchant identifier of the merchant and control measures limiting withdrawal of funds in the credited amount from the linked pre-paid debit account to transactions initiated with the merchant; (b) receiving a first transaction authorization request message for a purchase transaction initiated by the user with the merchant, the first transaction authorization request message including the merchant identifier of the merchant, a transaction amount, and account identifier of the linked pre-paid debit account; (c) performing a lookup in the memory using the merchant identifier to retrieve the credit record identifying the credited amount of funds available for withdrawal from the linked pre-paid debit account; (d) comparing the transaction amount to the credited amount of funds; (e) when the transaction amount is greater than the credited amount of funds: (i) modifying the first transaction authorization request message to generate a second transaction authorization request message, and (ii) transmitting the second transaction authorization request message to an issuer of another payment account associated with the user for authorization processing, and (f) when the transaction amount is less than or equal to the credited amount of funds, initiating a pre-paid debit transaction with the merchant and excluding the issuer.

Additionally or alternatively, the technical solutions may be achieved by performing at least one of the following steps: (g) receiving, from a plurality of merchant computing devices, a respective plurality of incentive structures defining respective incentives to be awarded upon satisfaction of one or more incentive conditions; (h) storing, in a memory, the plurality of incentive structures; (i) generating a visual representation of at least one of the plurality of incentive structures for display within a user interface of an account management software application stored and executed on a user computing device of a user; (j) receiving, from the user computing device, a user selection of a pre-payment transaction associated with a first incentive structure of the plurality of incentive structures; (k) identifying, from the user selection, a merchant identifier, a pre-payment amount, and a pre-payment transaction type of the pre-payment transaction; (l) comparing the merchant identifier, pre-payment amount, and pre-payment transaction type to the first incentive structure to determine whether the pre-payment transaction satisfies all incentive conditions of the first incentive structure; (m) when the pre-payment transaction satisfies all incentive conditions of the first incentive structure, initiating a transfer of funds in the pre-payment amount from a financial account associated with the user to a financial account associated with a merchant identified by the merchant identifier; and (n) storing, in the memory, a credit record of a credited amount to be credited to a linked pre-paid debit account associated with the user, the credited amount including the pre-payment amount as well as an incentive amount identified in the first incentive structure, wherein the credit record includes the merchant identifier and limits withdrawal of funds in the credited amount from the linked pre-paid debit account to transactions initiated with the merchant.

As used herein, the term “database” may refer to either a body of data, a relational database management system (RDBMS), or to both. A database may include any collection of data including hierarchical databases, relational databases, flat file databases, object-relational databases, object oriented databases, and any other structured collection of records or data that is stored in a computer system. The above examples are for example only, and thus are not intended to limit in any way the definition and/or meaning of the term database. Examples of RDBMS's include, but are not limited to including, Oracle® Database, MySQL, IBM® DB2, Microsoft® SQL Server, Sybase®, and PostgreSQL. However, any database may be used that enables the systems and methods described herein. (Oracle is a registered trademark of Oracle Corporation, Redwood Shores, California; IBM is a registered trademark of International Business Machines Corporation, Armonk, New York; Microsoft is a registered trademark of Microsoft Corporation, Redmond, Washington; and Sybase is a registered trademark of Sybase, Dublin, California.)

As used herein, a “processor” may include any programmable system including systems using central processing units, microprocessors, micro-controllers, reduced instruction set circuits (RISC), application specific integrated circuits (ASICs), logic circuits, and any other circuit or processor capable of executing the functions described herein. The above examples are example only, and are thus not intended to limit in any way the definition and/or meaning of the term “processor.”

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are example only, and are thus not limiting as to the types of memory usable for storage of a computer program.

In one embodiment, a computer program is provided, and the program is embodied on a computer readable medium. In an example embodiment, the system is executed on a single computer system, without requiring a connection to a server computer. In a further example embodiment, the system is being run in a Windows® environment (Windows is a registered trademark of Microsoft Corporation, Redmond, Washington). In yet another embodiment, the system is run on a mainframe environment and a UNIX® server environment (UNIX is a registered trademark of X/Open Company Limited located in Reading, Berkshire, United Kingdom). In a further embodiment, the system is run on an iOS® environment (iOS is a registered trademark of Cisco Systems, Inc. located in San Jose, CA). In yet a further embodiment, the system is run on a Mac OS® environment (Mac OS is a registered trademark of Apple Inc. located in Cupertino, CA). The application is flexible and designed to run in various different environments without compromising any major functionality. In some embodiments, the system includes multiple components distributed among a plurality of computing devices. One or more components are in the form of computer-executable instructions embodied in a computer-readable medium.

The systems and processes are not limited to the specific embodiments described herein. In addition, components of each system and each process can be practiced independent and separate from other components and processes described herein.

As used herein, an element or step recited in the singular and proceeded with the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional embodiments that also incorporate the recited features.

The following detailed description illustrates embodiments of the disclosure by way of example and not by way of limitation. It is contemplated that the disclosure has general application to management of financial instruments.

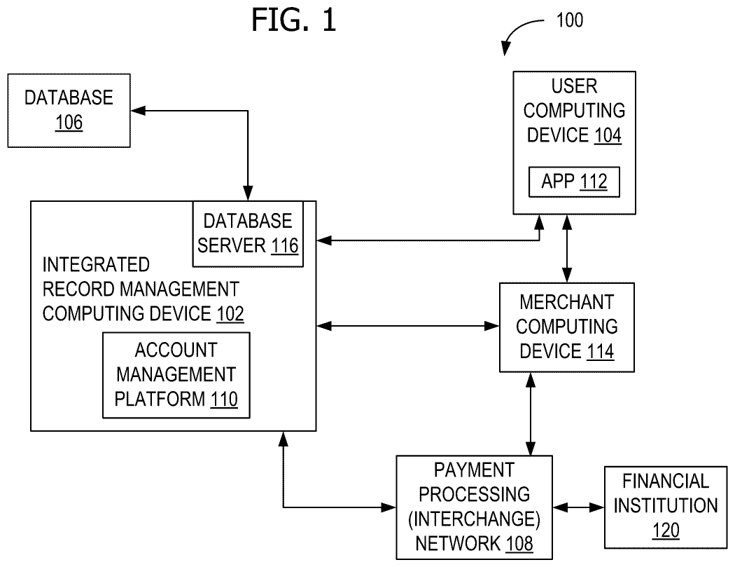

FIG. 1 is a simplified block diagram of an example virtual pre-payment management (VPM) computing system 100 used for recommending and processing pre-payments and associated incentives, in accordance with one example embodiment of the present disclosure.

In an example embodiment, system 100 is a computing system for centralized message routing and pre-payment management across multiple merchants for a user within a centralized computer-based platform, and is used to generate a linked pre-paid debit account, monitor transactions associated with that pre-paid debit account and one or more other payment accounts associated with the user, and to maintain a centralized database, as described herein. System 100 includes at least one integrated record management (IRM) computing device 102. In addition, system 100 includes one or more user computing devices 104, each associated with a respective user (not shown), and one or more centralized databases 106. In some embodiments, system 100 is associated with or integral to a payment processing network 108, such that system 100 may leverage existing relationships and communication channels and may conduct pre-payment transactions (e.g., debit and/or credit transactions), pre-paid debit transactions, modified transactions, and hybrid transaction over payment processing network 108. In other embodiments, system 100 is separate from but in communication with such a payment processing network 108.

IRM computing device 102 is configured to maintain an account management platform 110, accessible to users of system 100 using a respective user computing device 104. Account management platform 110 is accessible, for example, over a website and/or a software application stored and/or executed on the user computing device 104 - collectively referred to herein as an account management app 112. Account management app 112 enables communication between user computing device and IRM computing device 102 (e.g., via an API). Account management app 112 also enables a user to review and select or purchase incentives offered by various merchants for pre-paying the merchants or pre-funding a virtual debit card (i.e., the linked pre-paid debit account) with credits useable at the merchant. Additionally, account management platform 110 is accessible to a merchant (e.g., via a merchant computing device 114), to input incentive structures and associated rules or conditions for offers and incentives.

In some embodiments, user computing devices 104 include computers configured to implement a web browser or a software application, which enables user computing devices 104 to access IRM computing device 102 using the Internet (e.g., via account management app 112). User computing devices 104 may be communicatively coupled to the Internet through many interfaces including, but not limited to, at least one of a network, such as the Internet, a local area network (LAN), a wide area network (WAN), or an integrated services digital network (ISDN), a dial-up-connection, a digital subscriber line (DSL), a cellular phone connection, and a cable modem. User computing devices 104 include any device capable of accessing the Internet including, but not limited to, a desktop computer, a laptop computer, a personal digital assistant (PDA), a cellular phone, a smartphone, a tablet, a phablet, or other web-based connectable equipment.

In the example embodiment, IRM computing device 102 is communicatively coupled to a plurality of merchant computing devices 114, each merchant computing device 114 associated with a merchant that offers incentives for pre-payment (“participating merchant”). Accordingly, where reference is made to functions performed by “merchants,” such functions may be implemented using one or more merchant computing devices 114. Merchant computing devices 114 may include, without limitation, machines that accept card swipes, machines that accept chip card insertions, online payment portals, digital wallet payments, or stored payment card numbers for purchase transactions. Merchant computing devices 114 may additionally or alternatively include any device capable of accessing the Internet including, but not limited to, a desktop computer, a laptop computer, a personal digital assistant (PDA), a cellular phone, a smartphone, a tablet, a phablet, or other web-based connectable equipment. In some embodiments, merchant computing devices 114 are communicatively coupled with IRM computing device 102 through the Internet (e.g., to transmit incentive structures, as described herein) and/or through payment processing network 108 (e.g., to transmit transaction authorization request messages and receive transaction authorization response messages).

IRM computing device 102 receives, from merchant computing devices 114, the various incentives being offered by participating merchants as a data structure referred to as an “incentive structure.” The incentive structure includes incentive conditions that must be satisfied to receive an incentive, broadly referred to as “incentive amount.” The incentive conditions may be embodied as an array of data elements or a table, for example. The incentive structure includes data elements defining each of the incentives offered by the participating merchant and the incentive conditions associated therewith. The incentive structure also includes a merchant identifier that associates the incentives being offered with the particular participating merchant. IRM computing device 102 stores the incentive structures in one or more databases 106 and/or another memory, which may be integral to IRM computing device 102 or a separate database or memory communicatively coupled to IRM computing device 102.

In an exemplary embodiment, IRM computing device 102 includes a database server 116 that is communicatively coupled to database 106 for storing data therein. For example, database 106 stores incentive structures, transaction histories, credit records, transactions records, and any other information described herein. According to the exemplary embodiment, database 106 is disposed remotely from IRM computing device 102. In other embodiments, database 106 is decentralized, or may be a portion of IRM computing device 102.

IRM computing device 102 is configured to generate a visual representation of one or more of the stored incentive structures for display to a user within the user interface of account management app 112. The visual representation may include text, images, charts (e.g., pie charts, bar charts, line graphs, etc.), and the like. The visual representation may also include ranking or sorting the incentive structures prior to display (e.g., alphabetically, in order of value of the incentive offered, by merchant category, etc.), as well as comparisons of incentive structures (e.g., between merchants in a same merchant category). IRM computing device 102 may display any number of visual representations of incentive structures.

In some embodiments, IRM computing device 102 leverages a user's previous transaction history to determine which incentives to display. The transaction history includes transaction data for a plurality of transactions initiated by the user with a plurality of merchants over a period of time (e.g., the past six months, the past year, the past two years, etc.). IRM computing device 102 may access the transaction history from a transaction database (e.g., database 106) and/or may request or receive the transaction history from a payment processor (not shown) of payment processing network 108. The transaction history includes purchase transactions made by the user using one or more payment accounts and/or payment cards associated therewith.

IRM computing device 102 is configured to analyze the transaction history to make recommendations to a user, such as which merchants to pre-pay in return for incentives. IRM computing device 102 analyzes the transaction history as well as the stored incentive structures to determine correlations therebetween, and generates recommendations based on those correlations. In some embodiments, IRM computing device 102 is configured to identify, based on the transaction history, a subset of merchants with which the user regularly or frequently transacts. IRM computing device 102 may then perform a lookup in database 106 (e.g., using merchant identifiers of the subset of merchants) to identify any incentive(s) offered by these merchants, and display those incentives offered to the user via account management app 112.

In some such embodiments, IRM computing device 102 is also configured to compute or calculate an average monthly spend, by the user, at each of the merchants in the subset. Based on the average monthly spend, IRM computing device 102 may perform a lookup in database 106 (e.g., using merchant identifiers of the subset of merchants and/or the average monthly spend at each merchant) to identify any incentive(s) offered by these merchants. IRM computing device 102 displays these incentives, to encourage the user to pre-pay the merchant for their average monthly spend in exchange for the incentive.

In some embodiments, IRM computing device 102 may be configured to identify and display incentives offered for “competitor merchants,” or merchants in the same merchant category as the subset of merchants (i.e., the merchants with which the user regularly transacts). These merchants may present more competitive incentives in an attempt to capture at least a portion of the user's spend. In these embodiments, IRM computing device 102 may be configured to identify competitor merchants based on the merchant category (e.g., a merchant category code) for the subset of merchants and/or a merchant name or identifier in a user search inquiry, retrieve the incentive structures for the competitor merchants, and generate the visual representation of the incentives offered by the competitor merchants as well as the subset of merchants and/or merchants that are the subject of a user search inquiry. Additionally, where a user regularly transacts at a merchant that is not offering any incentive (e.g., is not a participating merchant), IRM computing device 102 may identify a similar competitor merchant, such as a participating merchant with a same merchant category code (MCC), and recommend that the user shift their spend to the similar competitor merchant, to earn the additional benefits offered through an incentive structure with the similar competitor merchant.

The user may access account management app 112 using their user computing device 104, to view the visual representation of the incentive structures, representing the incentives offered by participating merchants for pre-paying those merchants. In some embodiments, account management app 112 may provide various user controls that enable the user to control which incentives are displayed and/or how those incentives are displayed. The user may also search for participating merchants and/or merchant categories to view any incentive(s) offered thereby. In addition, the user may review their transaction histories, subsets of merchants with which they frequently transact, and their spend thereat (including the raw spend at these merchants and/or the average monthly spend). The user may also use account management app 112 to manage access to their transaction history, such as opting in to providing their transaction history to IRM computing device 102, adding or removing payment accounts and/or associated cards for transaction and spend monitoring, and/or opting out.

When the user identifies an incentive they wish to receive (i.e., by pre-paying the merchant according to the incentive conditions), the user selects the incentive within the user interface of account management app 112. In some embodiments, account management app 112 may display one or more dialog boxes to the user, asking for additional information and/or confirmation of their selection. In the example embodiment, the user provides a pre-payment amount and a pre-payment transaction type (i.e., one-time or recurring). The user-selected incentive and any user-provided information is formatted as a pre-payment transaction message (e.g., by account management app 112) and transmitted to IRM computing device 102.

IRM computing device 102 receives the user selection of their pre-payment transaction as represented by the pre-payment transaction message. The pre-payment transaction message includes data elements such as a merchant associated with the selected incentive (e.g., a merchant name, merchant identifier, etc.), the pre-payment amount, and the pre-payment transaction type. The pre-payment transaction message may also include an identifier of the specific incentive selected by the user, for example, where a merchant has multiple active incentive structures.

In the example embodiment, IRM computing device 102 identifies the user-selected incentive based on data in the pre-payment transaction message and retrieves the associated incentive structure from database 106. IRM computing device 102 compares the data in the pre-payment transaction message with the incentive structure to determine whether the pre-payment transaction satisfies all of the incentive conditions of the incentive structure and, therefore, the user is eligible to receive the incentive offered in the incentive structure. In particular, IRM computing device 102 compares the merchant, pre-payment amount, and pre-payment transaction type to the first incentive structure to determine whether the pre-payment transaction satisfies all incentive conditions of the first incentive structure.

When all of the incentive conditions are satisfied, IRM computing device 102 is configured to initiate a transfer of funds in the pre-payment amount from a financial account associated with the user to a financial account associated with the merchant. IRM computing device 102 may initiate the transfer, for example, by transmitting instructions (e.g., over payment processing network 108, an ACH network, etc.) to the issuer of the user's financial account (represented as a financial institution 120 in FIG. 1) to transmit the funds in the pre-payment amount to the financial account associated with the merchant.

In some cases, the financial account associated with the merchant is a financial account from which the merchant can make withdrawals as desired. In other cases, the financial account associated with the merchant is a holding account maintained at a third-party financial institution 120, and funds from the holding account are only made available to the merchant when the user actually makes a purchase with the merchant, as described further herein.

IRM computing device 102 also generates a credit record associated with the pre-payment transaction and stores the credit record in database 106. The credit record serves as a record that the user has pre-paid the merchant in the pre-payment amount and has received an incentive in exchange. Therefore, the user has “credits” in an amount equal to the sum of the pre-payment amount and the incentive amount. The credits (which include credits in a monetary value as well as any other incentives) are stored in the linked pre-paid debit account and are available to apply to future purchases with that merchant. The credit record includes the credited amount, as well as an identifier of the user, the user's pre-paid debit account, and/or the user's payment account used to initiate the pre-payment transaction. The credit record also includes an identifier of the merchant and limits withdrawal of funds in the credited amount from the linked pre-paid debit account to transactions initiated with that merchant.

IRM computing device 102 may store any number of credit records for the user, each credit record detailing a separate pre-payment transaction, the incentives received, and the credited amount added to the user's pre-paid debit account but limited to withdrawals to transactions initiated with the corresponding participating merchant. Additionally or alternatively, IRM computing device 102 may modify, update, or delete credit records in response to subsequent pre-payment transactions (which increase the credited amount available for payment of transactions with associated merchants) and/or purchase transactions (which decrease the credit amount). An overall credited amount available to the user in the pre-paid debit account may be displayed to the user within the user interface of account management app 112, as well as the individual credited amount(s) associated with each of a plurality of merchants that the user has pre-paid.

In embodiments where the user has selected an incentive based on recurring pre-payment transactions, IRM computing device 102 may be configured to initiate subsequent pre-payment transactions at the interval agreed to by the user. For example, a user selected a pre-payment incentive based on monthly pre-payment transactions of a particular pre-payment amount. After a month has elapsed from the first pre-payment transaction, IRM computing device 102 may initiate a second transfer of funds in the same pre-payment amount from the financial account associated with the user to the financial account associated with the merchant. IRM computing device 102 may further generate a new credit record associated with this second pre-payment transaction and/or update, in database 106, the existing credit record with an updated credited amount, by adding the pre-payment amount and the incentive amount to any remaining credited amount in the linked pre-paid debit account. The user may access account management platform 110 (e.g., via account management app 112) to manage any recurring payments, such as adjusting a recurring payment amount, adjusting a recurring payment frequency, or cancelling a recurring payment.

As described above, the credited, pre-paid funds are available for the user to use during purchase transactions with the merchant(s) that the user has pre-paid. The user may access these funds using their digital wallet (e.g., via their user computing device 104) or virtual pre-paid debit card to initiate a purchase transaction with the merchant. Additionally or alternatively, the user may have and use a physical pre-paid debit card to initiate a purchase transaction with the merchant. These payment credentials, associated with the linked pre-paid debit account, may be used to initiate one or more of pre-paid debit transactions, hybrid pre-paid/real-time transactions, and modified purchase transactions, as described further herein.

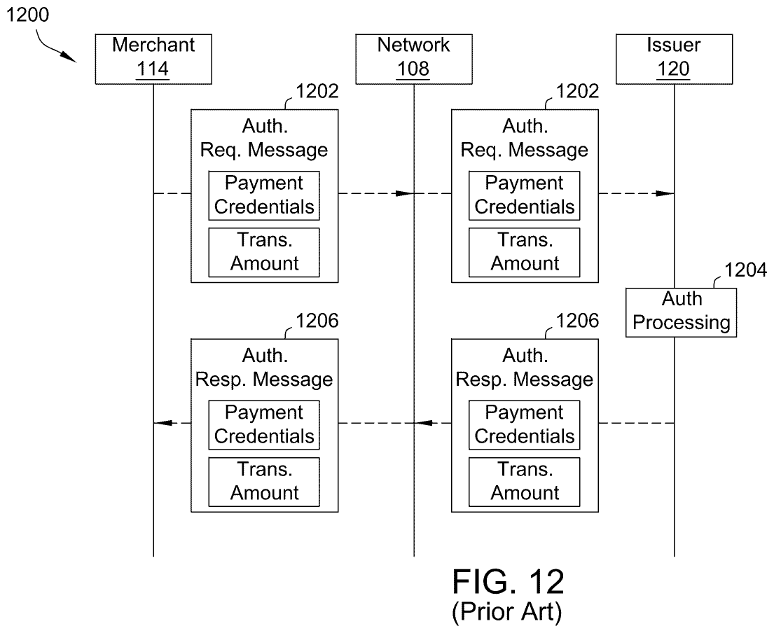

Turning to FIG. 12, a conventional transaction processing flow 1200 is depicted. Financial institution 120, also referred to herein as issuer 120, issues a payment account card, such as a credit card account or a debit card account, to a cardholder. The cardholder uses the payment account card to tender payment for a purchase from a merchant 114. To accept payment with the payment account card, merchant 114 must normally establish an account with a financial institution that is part of the financial payment system. This financial institution is usually called the “merchant bank, the “acquiring bank”, or simply the “acquirer”. With reference to conventional transaction processing flow 1200, when the cardholder tenders payment for a purchase with their payment account card, merchant 114 requests authorization from the acquirer (not specifically shown in FIG. 12) for the amount of the purchase. Using payment network 108, the computers of merchant 114 (and/or the acquirer) will communicate with the computers of issuer 120, to determine whether the cardholder's account is in good standing and whether the purchase is covered by the cardholder's available credit line or account balance. Specifically, merchant 114 transmits an authorization request message 1202, via payment network 108, to issuer 120. Authorization request message 1202 includes, in part, payment credentials associated with the cardholder's payment account card, and a transaction amount. Based on the determinations made during authorization processing 1204 by issuer 120, the request for authorization will be declined or accepted. Issuer 120 transmits an authorization response message 1206, via payment network 108, back to acquirer/merchant 114. Authorization response message 1206 includes, in part, the same payment credentials and (authorized) transaction amount as authorization request message 1202.

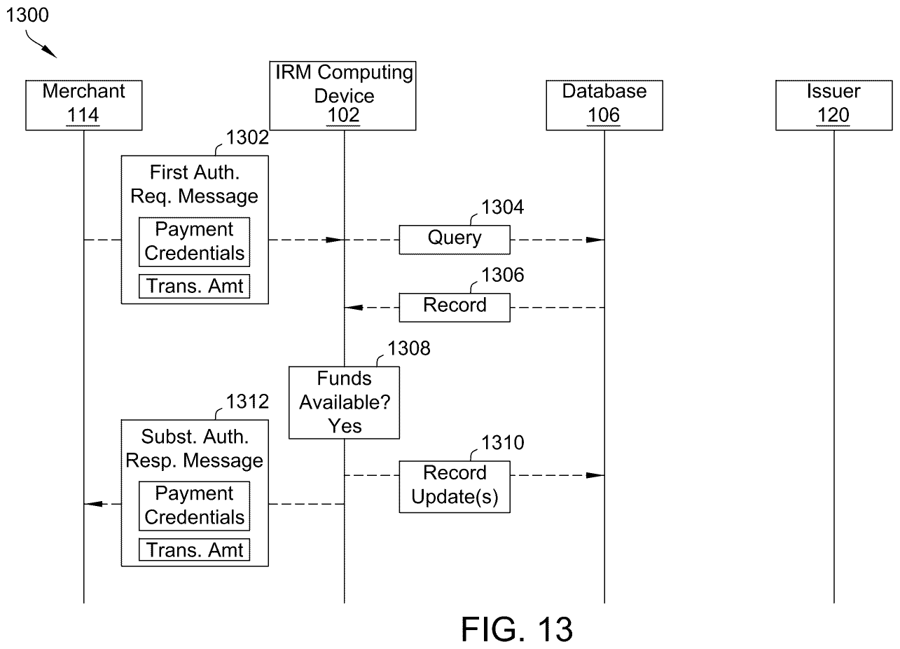

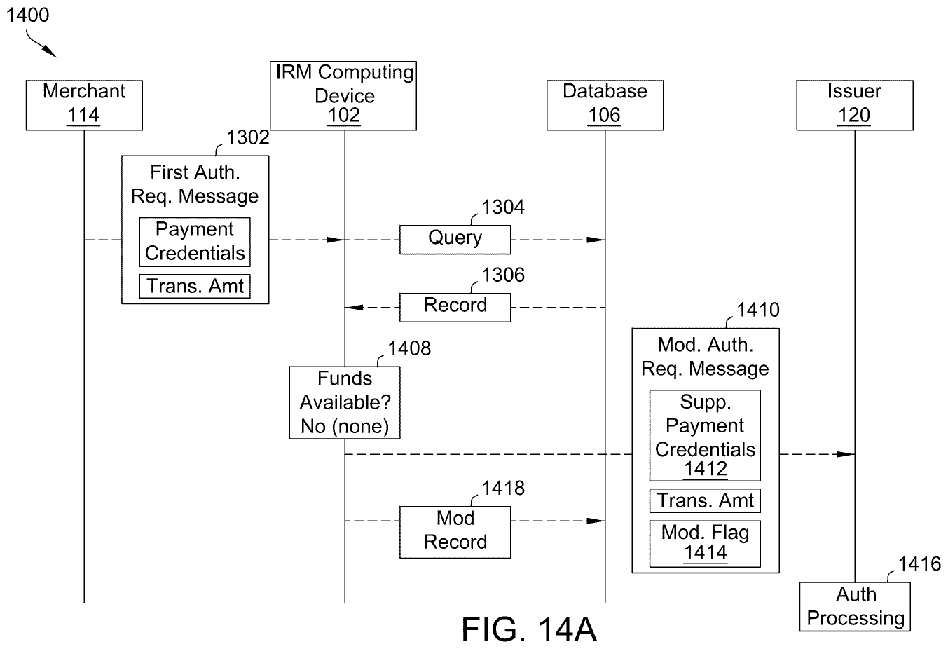

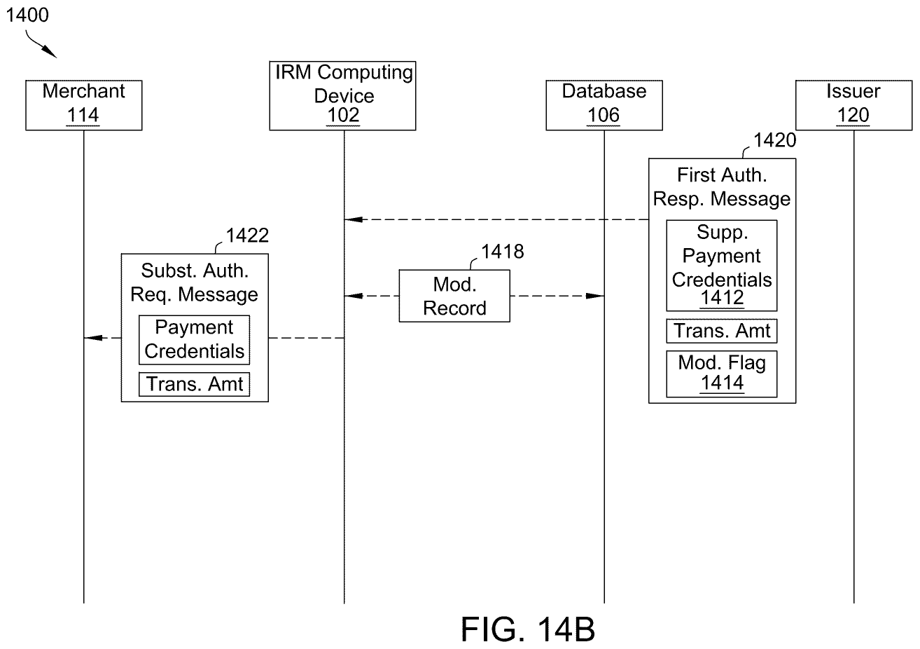

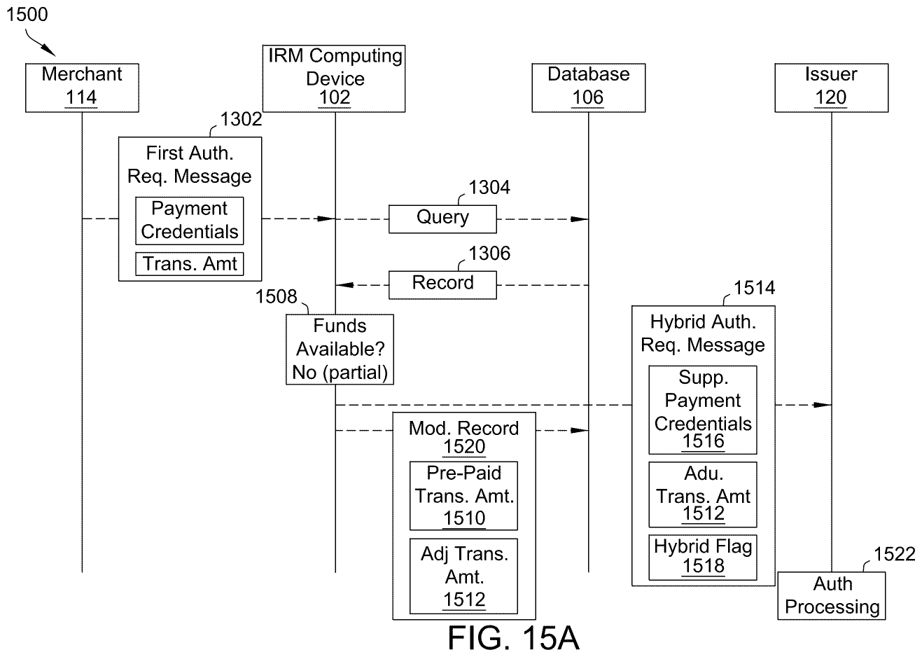

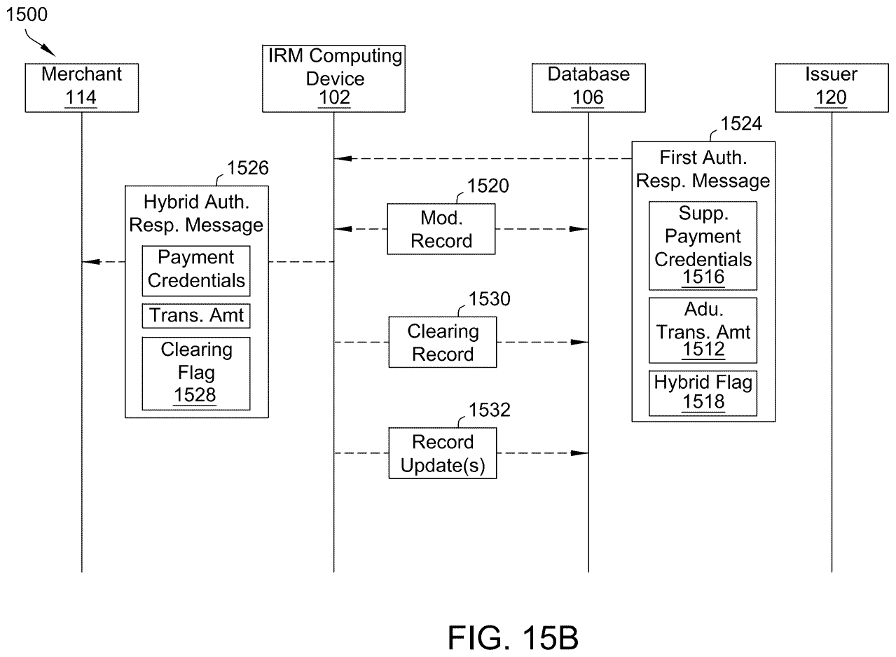

With reference now to FIG. 1 and to FIGS. 13-15B, in accordance with the present disclosure, upon initiation of the purchase transaction, the purchase transaction may be processed according to a pre-paid transaction processing flow 1300 (see FIG. 13), a modified transaction processing flow 1400 (see FIGS. 14A and 14B), or a hybrid transaction processing flow 1500 (see FIGS. 15A and 15B).

In each instance, the merchant (e.g., via merchant computing device 114) transmits a first transaction authorization request message 1302 requesting authorization of the purchase transaction. First transaction authorization request message 1302 is formatted as an ISO 8583 network authorization message, and includes the payment credentials of the linked pre-paid debit account as well as a total transaction amount. First transaction authorization request message 1302 is processed over payment processing network 108 (not shown in FIGS. 13-15B). In some embodiments, IRM computing device 102 may be associated with and/or integral to payment processing network 108, and receives the transaction authorization request message directly.

IRM computing device 102 receives first transaction authorization request message 1302, which includes payment credentials (e.g., an account identifier) of the linked pre-paid debit account, a merchant identifier of the merchant with which the transaction was initiated, and a total transaction amount (e.g., a purchase amount). IRM computing device 102 uses the account identifier to perform a lookup in database 106 (e.g., via a query 1304), to retrieve all credit records 1306 associated with the linked pre-paid debit account of the user. IRM computing device 102 also performs a lookup in database 106 using the merchant identifier, which filters the retrieved credit records 1306 to only the credit record(s) associated with that merchant.

In some instances, as shown in FIG. 13, IRM computing device 102 determines (at 1308) that the total transaction amount (or the adjusted transaction amount, where any discounts or coupons are applied) is less that a total credited amount of funds identified in the corresponding credit record 1306. That is, the purchase transaction can be completed paid for using credited/pre-paid funds. In such instances, IRM computing device 102 updates (at 1310) the corresponding credit record.

For example, to deduct the transaction amount from the credited amount of funds, IRM computing device 102 is configured to generate a transaction record associated with the purchase transaction, and store the transaction record in database 106, in a memory location associated with the credit record, to track withdrawals of the credited amount of funds from the linked pre-paid debit account. The transaction record includes a record of the purchase transaction, the transaction amount deducted from the credit amount, and any other information associated with the deduction. In some cases, the transaction record is a new file generated and stored by IRM computing device 102; in other cases, the transaction record represents an update or modification to the existing credit record 1306.

In other embodiments, the value of the pre-paid funds has been withdrawn from the financial account of the user and transferred to a holding account at a third-party financial institution 120 (not shown in FIG. 13). That is, the funds have not actually been provided to merchant 114. In such embodiments, when the purchase transaction is approved, IRM computing device 102 transmits an instruction to third-party financial institution 120 to transmit funds in a value proportional to the transaction amount from the holding account associated with merchant 114 to a financial account of merchant 114 where the funds are readily available to merchant 114 without restriction.

IRM computing device 102 also generates a substitute authorization response message 1312 for transmission back to merchant 114, without first transaction authorization request message 1302 being transmitted to issuer 120 (or any other downstream party). Substitute authorization response message 1312 is formatted as a network message (e.g., an ISO 8583 network authorization message) and transmitted back to merchant 114. Merchant 114 processes substitute authorization response message 1312 as normal. In these instances, IRM computing device 102 facilitates reduced messaging across the conventional payment processing network, by intercepting first transaction authorization request message 1302 and, when the total transaction amount is fully covered by the credited amount of funds in the linked pre-paid debit account, generating and transmitting substitute transaction authorization response message 1312 without further downstream messaging (e.g., to/from issuer 120).

In other instances, as shown in FIGS. 14A and 14B, IRM computing device 102 determines (at 1408) that the linked pre-paid debit account has no available funds to be applied to the purchase transaction. For example, the user may use the payment credentials associated with the linked pre-paid debit account, but may have not pre-paid that particular merchant 114, or may have already used all available credited funds. In such cases, IRM computing device 102 determines whether the user has identified any other payment account to be used when credited funds are unavailable. For example, the user may use account management platform 110 to identify a traditional payment account (e.g., credit or debit account) to make initial pre-payment transactions. The user may select an option to have this account made available to conduct purchase transactions that are initiated with the payment credentials of the linked pre-paid debit account, but where credited funds are insufficient to cover a total transaction amount. That is, the user may identify one traditional payment account as a supplemental payment account.

If the user has made such a selection and identification of the supplemental payment account, IRM computing device 102 is configured to generate a modified transaction authorization request message 1410. Modified transaction authorization request message 1410 is formatted as a network message (e.g., an ISO 8583 network authorization message), and includes the total transaction amount, the merchant identifier, and other information from first transaction authorization request message 1302. However, IRM computing device 102 replaces the payment credentials associated with the linked pre-paid debit account with the payment credentials of the supplemental payment account (supplemental payment credentials 1412), to generate modified transaction authorization request message 1410. Modified transaction authorization request message is then transmitted (e.g., over payment network 108) to issuer 120 of the supplemental payment account for authorization processing 1416.

IRM computing device 102 may store a record 1418 of any such modifications, the modification record 1418 including the payment credentials of the linked pre-paid debit account, used to initiate the transaction, and supplemental payment credentials 1412. Modification record 1418 may include additional data elements, such as some identifier of the transaction, the transaction amount, the merchant identifier, and the like. IRM computing device 102 stores modification record 1418 in an internal memory and/or in database 106.

IRM computing device 102 may also add one or more data elements to modified transaction authorization request message 1410 before modified transaction authorization request message 1410 is transmitted to issuer 120, including a modification flag 1414. Modification flag 1414 identifies the corresponding transaction as modified by IRM computing device 102, and, upon processing by issuer 120, causes issuer 120 to append modification flag 1414 to any subsequent transaction authorization response message (e.g., an approval or decline transaction authorization response message), such as a first transaction authorization response message 1420. When first transaction authorization response message 1420 is processed over payment network 108, modification flag 1414 causes first transaction authorization response message 1420 to be routed to IRM computing device 102. IRM computing device 102 interprets modification flag 1414, parses data (e.g., supplemental payment credentials 1412, a transaction identifier, etc.) from first transaction authorization response message 1420, and uses that parsed data to query database 106 for a corresponding modification record 1418.

IRM computing device 102 uses retrieved modification record 1418 to modify first transaction authorization response message 1420 and generate a modified transaction authorization response message 1422. Specifically, IRM computing device 102 replaces supplemental payment credentials 1412 with the (original) payment credentials of the linked pre-paid debit account used to initiate the purchase transaction. In this way, modified transaction authorization response message 1422 is transmitted back to merchant 114, which can readily match modified transaction authorization response message 1422 to first transaction authorization request message 1302, and can process modified transaction authorization response message 1422 as normal—that is, without any knowledge of the use of the supplemental payment account.

In still other instances, as shown in FIGS. 15A and 15B, IRM computing device 102 determines (at 1508) that the credited amount of funds in the linked pre-paid debit account only covers a portion of the total transaction amount. In these cases, IRM computing device 102 may perform hybrid transaction processing according to flow 1500, which is a hybrid between modified transaction processing flow 1400 and pre-paid debit transaction processing 1300. Specifically, first transaction authorization request message 1302 is routed to IRM computing device 102. At 1508, IRM computing device 102 compares the total transaction amount to the credited amount of funds in the linked pre-paid debit account that are available to credit to purchases with merchant 114. IRM computing device 102 applies all available credited funds to the total transaction amount and determines a pre-paid amount 1510 and an adjusted transaction amount 1512. Adjusted transaction amount 1512 is the (original) total transaction amount, less pre-paid amount 1510, which includes the credited funds (and any applicable coupons/discounts).

IRM computing device 102 generates a hybrid transaction authorization request message 1514, which is formatted as a network message (e.g., an ISO 8583 network authorization message). IRM computing device 102 replaces (i) the total transaction amount with adjusted transaction amount 1512, and (ii) the payment credentials of the linked pre-paid debit account with the payment credentials of the supplemental payment account (supplemental payment credentials 1516), to generate hybrid transaction authorization request message 1514. IRM computing device 102 also appends a hybrid flag 1518 (which may be formatted similarly to modification flag 1414 described above) to hybrid transaction authorization request message 1514. Hybrid flag 1518 causes issuer 120 to also append hybrid flag 1518 to any subsequent authorization response, and causes any such authorization response to be routed back to IRM computing device 102.

IRM computing device 102 may further generate a modification record 1520, as described above. Modification record 1520 includes the (original) payment credentials of the linked pre-paid debit account used to initiate the transaction, supplemental payment credentials 1516, pre-paid transaction amount 1510, and adjusted transaction amount 1512.

IRM computing device 102 transmits hybrid authorization request message 1514 to issuer 120 of the supplemental payment account for authorization processing 1522. Issuer 120 transmits a first transaction authorization response message 1524, including hybrid flag 1518, for processing over network 108. Hybrid flag 1518 causes first transaction authorization response message 1524 be routed to IRM computing device 102. IRM computing device 102 interprets hybrid flag 1518, parses data (e.g., supplemental payment credentials 1516, a transaction identifier, etc.) from first transaction authorization response message 1524, and uses that parsed data to query database 106 for a corresponding modification record 1520.

IRM computing device 102 uses the retrieved modification record 1520 to modify first transaction authorization response message 1524 and generate a hybrid transaction authorization response message 1526. Specifically, IRM computing device 102 replaces supplemental payment credentials 1516 with the original payment credentials of the linked pre-paid debit account used to initiate the purchase transaction. IRM computing device 102 also replaces adjusted transaction amount 1512 with the (original) total transaction amount. In this way, hybrid transaction authorization response message 1526 is transmitted back to merchant 114, which can can readily match hybrid transaction authorization response message 1526 to first transaction authorization request message 1302, and can process hybrid transaction authorization response message 1526 as normal—that is, without any knowledge of the use of the supplemental payment account.

IRM computing device 102 generates and/or stores any additional records 1530 necessary to facilitate subsequent “hybrid” clearing and settlement of the transaction, which includes typical transfer of funds in adjusted transaction amount 1512 between issuer 120 and the merchant's acquirer, as well as any applicable “release” of pre-paid funds to merchant 114 in pre-paid transaction amount 1510. In some instances, IRM computing device 102 appends a clearing flag 1528 to hybrid transaction authorization response message 1526. Clearing flag 1528 flags the hybrid transaction for clearing/settlement as described above. Clearing flag 1528 may reference a clearing record 1530 stored in database 106, such that pre-paid amount 1510 and adjusted transaction amount 1512 are readily retrieved and identified during clearing/settlement. IRM computing device 102 also updates (at 1532) the corresponding credit record 1306 based on the debiting of funds in pre-paid amount 1510 from the linked pre-paid debit account.

In some cases, where the user initiates a purchase transaction with a transaction amount that exceeds the credited amount of funds available for use with that merchant, IRM computing device 102 is configured to identify whether the merchant has any active incentives that may be offered to the user, such that the user may replenish their credited funds with the merchant. IRM computing device 102 may perform a lookup in database 106 using the merchant identifier to retrieve any incentive structures associated with the merchant. If any incentives are available—as represented by any retrieved incentive structures - IRM computing device 102 may display those incentives to the user, for example, in a dialog box on their user computing device 104. The user may select a displayed incentive for purchase, and the above-described process of performing a pre-payment transaction and crediting funds to the user may be implemented. IRM computing device 102 may then apply the newly credited funds to the current purchase transaction.

In some other embodiments, such as where the user has not identified any supplemental payment account, IRM computing device 102 may intercept first transaction authorization request message 1302 and, without transmitting first transaction authorization request message 1302 to any issuer, generate a decline response message (not shown) for transmittal back to merchant 114. Alternatively, IRM computing device 102 may, in real-time during processing of the transaction, prompt the user to enter alternative payment credentials to cover the remaining amount of the purchase transaction. IRM computing device 102 may generate hybrid transaction authorization request message 1514 including those alternative payment credentials and the remaining amount of the purchase transaction (i.e., adjusted transaction amount 1512).

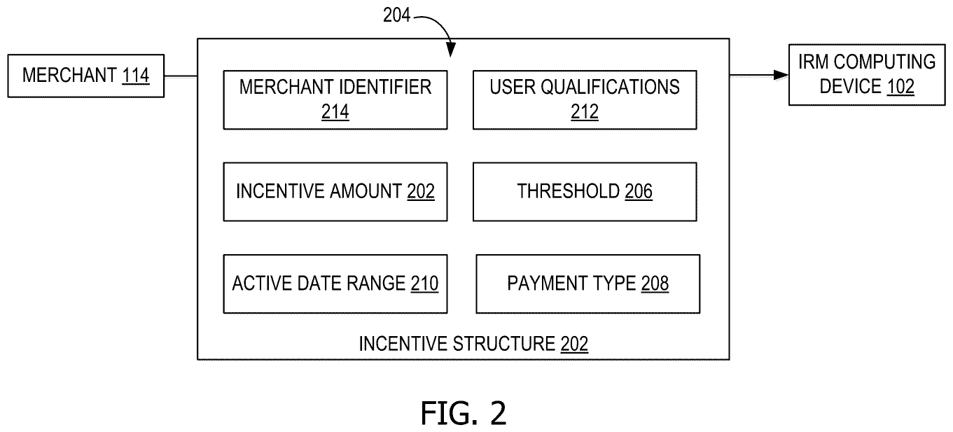

FIG. 2 is a simplified representation of an incentive structure 200 in accordance with the present disclosure. As described herein, each incentive structure 200 is received at IRM computing device 102 from a merchant computing device 114. Incentive structure 200 represents an incentive offered by the associated merchant for pre-payment of the merchant. Each participating merchant controls their own incentive offerings. Various incentive offerings may include immediate “cash-back” upon pre-payment (e.g., receive 10% cash back or a 10% additional credited amount, or receive $X cash-back), coupons (e.g., get an additional 10% off all payments), or other offerings.

In some cases, participating merchants may offer graduated incentives that are based on an amount and/or frequency of pre-payment. For example, a merchant may offer a 10% credit on all pre-payments greater than $200, but only 5% credit on pre-payment less than $200. As another example, a merchant may offer a 10% credit on recurring pre-payments (of any amount, or above a threshold amount), and a 5% credit on a one-time pre-payment (of any amount, or above a threshold amount). Incentives may also be variable based on other factors, for example, but not limited to, a transaction history with a particular customer, a time of year (e.g., greater incentives around a holiday shopping season), location, demographics, or a particular marketing campaign (e.g., offering greater incentives to customers in a particular spending band).

Incentive structure 200 includes all of the incentive conditions that must be satisfied to receive the associated incentive, broadly referred to as “incentive amount” 202. The incentive conditions may be embodied as an array or a table of data elements 204, for example. Incentive structure 200 includes data elements 204 defining each of the incentives offered by the participating merchant and the incentive conditions associated therewith. Data elements 204 may include, for example, the incentive amount 202 (which may be a discrete value or percentage, and/or may include discounts, coupons, etc.), one or more thresholds 206 (e.g., a minimum pre-payment amount to receive a particular incentive amount), a payment type condition 208 (e.g., one-time vs. recurring), an active date range 210 for the incentive, and/or any limiting factors such as qualifications 212 of the users to whom the incentive should be offered (e.g., only provide this to users with a purchase history spanning more than a year with the merchant, or users that have spent more than $1,000 within a year, etc.).

Incentive structure 200 also includes a merchant identifier 214 that associates the incentives being offered with the particular participating merchant. Merchant identifier 214 may be a merchant name, an alphanumeric code identifying the merchant, and/or any other merchant identifier. In some embodiments, merchant identifier 214 may include multiple variations that all apply to the same merchant (e.g., “MerchantName.com” as well as “Merchant Name” for brick-and-mortar locations; merchant identifiers associated with different branches of the same merchant; and the like).

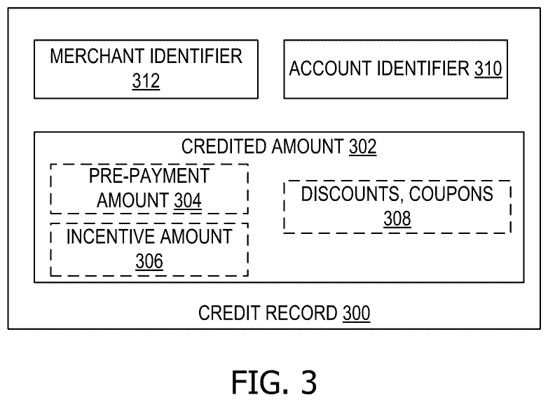

FIG. 3 is a simplified representation of a credit record 300 in accordance with the present disclosure. As described herein, credit record 300 is generated by IRM computing device 102 and stored in database 106 (both shown in FIG. 1) after a pre-payment transaction is completed.

Credit record 300 serves as a record that the user has pre-paid the associated merchant in a pre-payment amount and has received an incentive in exchange. Therefore, the user has “credits” in an amount equal to the sum of the pre-payment amount and the incentive amount (a credited amount 302). Credited amount 302 may be stored as a single data element and/or may be stored as multiple data elements including the pre-payment amount 304, any awarded incentive amount 306, and/or a total of the amount 304, 306 as the credited amount 302. Notably, as described above, the “incentive amount” 306 may refer to a specific amount of funds, based on pre-payment amount 304 and the specific incentive offered, but may alternatively include discounts or coupons to be applied to future purchases. In such cases, credited amount 302 may include pre-payment amount 304, and credit record 300 may include additional data elements 308 identifying the discounts or coupons to be applied (such that the discounts or coupons will be applied, as available, to one or more qualifying future purchases). Credits in the credited amount (which include credits in a monetary value as well as any other incentives) are stored in the linked pre-paid debit account and are available to apply to future purchases with that merchant.

Credit record 300 includes credited amount 302, as well as an identifier 310 of the user, the user's pre-paid debit account, and/or the user's payment account used to initiate the pre-payment transaction. Credit record 300 also includes an identifier 312 of the merchant, which serves as a control to limit withdrawal of funds in credited amount 302 from the linked pre-paid debit account to transactions initiated with that merchant.

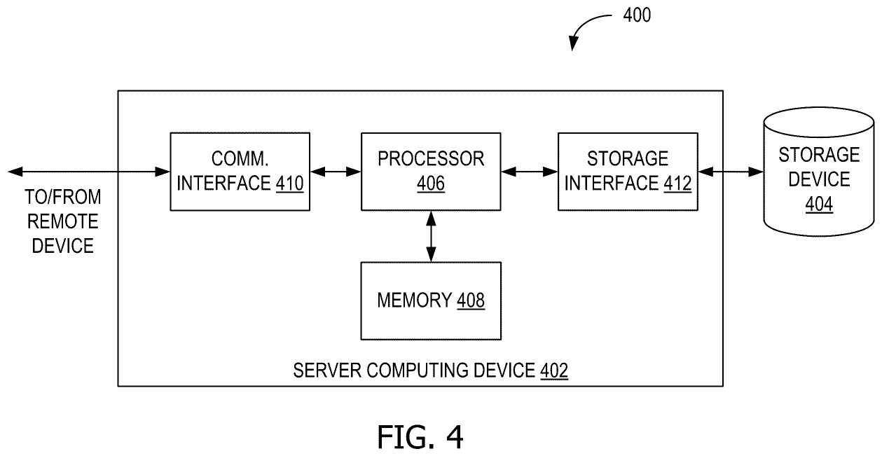

FIG. 4 illustrates an example configuration of a server system 400, in accordance with an embodiment of the present disclosure. In the example embodiment, server system 400 includes at least one server computing device 402, in electronic communication with at least one storage device 404. Server computer device 402 may be representative of, but is not limited to, one or more of IRM computing device 102, payment processors of payment processing network 108, merchant computing device 114, and/or database server 116 (all shown in FIG. 1). In the exemplary embodiment, server computer device 402 includes a processor 406 for executing instructions (not shown) stored in a memory area 408. In an embodiment, processor 406 may include one or more processing units (for example, in a multi-core configuration). The instructions may be executed within various different operating systems on server computer device 402, such as UNIX®, LINUX® (LINUX is a registered trademark of Linus Torvalds), Microsoft Windows®, etc. It should also be appreciated that upon initiation of a computer-based method, various instructions may be executed during initialization. Some operations may be required in order to perform one or more processes described herein, while other operations may be more general and/or specific to a particular programming language (for example, C, C#, C++, Java, or other suitable programming languages, etc.).

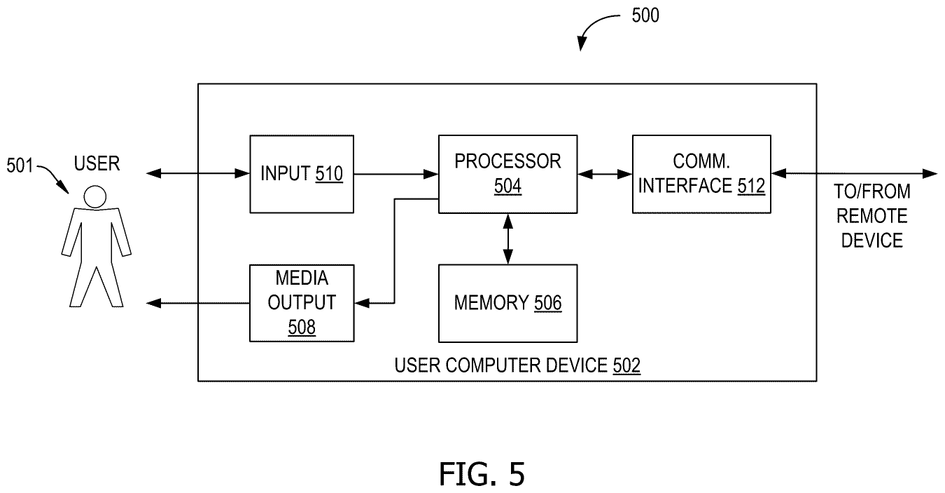

In the example embodiment, processor 406 is operatively coupled to a communication interface 410 such that server system 400 is capable of communicating with a remote device such as a user system or another server system 400. For example, communication interface 410 may receive requests from a client system 500 (see FIG. 5) via the Internet.

In the example embodiment, processor 406 is also operatively coupled to storage device 404, which may be, for example, a computer-operated hardware unit suitable for storing and/or retrieving data. In some embodiments, storage device 404 is integrated in server system 400. For example, server system 400 may include one or more hard disk drives as storage device 404. In other embodiments, storage device 404 is external to server system 400 and may be accessed by a plurality of server computing device 402. For example, storage device 404 may include multiple storage units such as hard disks or solid state disks in a redundant array of inexpensive disks (RAID) configuration. Storage device 404 may include a storage area network (SAN) and/or a network attached storage (NAS) system.

In some embodiments, processor 406 is operatively coupled to storage device 404 via an optional storage interface 412. Storage interface 412 may include, for example, a component capable of providing processor 406 with access to storage device 404. In an exemplary embodiment, storage interface 412 further includes one or more of an Advanced Technology Attachment (ATA) adapter, a Serial ATA (SATA) adapter, a Small Computer System Interface (SCSI) adapter, a RAID controller, a SAN adapter, a network adapter, and/or a similarly capable component providing processor 406 with access to storage device 404.

Memory area 408 may include, but is not limited to, random-access memory (RAM) such as dynamic RAM (DRAM) or static RAM (SRAM), read-only memory (ROM), erasable programmable read-only memory (EPROM), electrically erasable programmable read-only memory (EEPROM), non-volatile RAM (NVRAM), and magneto-resistive random-access memory (MRAM). The above memory types are for example only, and are thus not limiting as to the types of memory usable for storage of a computer program.

FIG. 5 illustrates an example configuration of a client system 500 in accordance with one embodiment of the present disclosure. In the example embodiment, client system 500 includes at least one user computer device 502, operated by a user 501. User computer device 502 may be representative of, but is not limited to, one or more of user computing devices 104 and merchant computing devices 114 (all shown in FIG. 1). User computer device 502 includes a processor 504 for executing instructions, and a memory area 506. In some embodiments, executable instructions are stored in memory area 506. Processor 504 may, for example, include one or more processing units (for example, in a multi-core configuration). Memory area 506 may, for example, be any device allowing information such as executable instructions and/or transaction data to be stored and retrieved. Memory area 506 may further include one or more computer readable media.

In the example embodiment, user computer device 502 further includes at least one media output component 508 for presenting information to user 501. Media output component 508 may, for example, be any component capable of converting and conveying electronic information to user 501. In some embodiments, media output component 508 includes an output adapter (not shown), such as a video adapter and/or an audio adapter, which is operatively coupled to processor 504 and operatively coupleable to an output device (also not shown), such as a display device (for example, a cathode ray tube [CRT], liquid crystal display [LCD], light emitting diode [LED] display, or “electronic ink” display) or an audio output device (for example, a speaker or headphones).

In some embodiments, media output component 508 is configured to include and present a graphical user interface (not shown), such as a web browser and/or a client application (e.g., account management app 112, shown in FIG. 1), to user 501. In some embodiments, user computer device 502 includes an input device 510 for receiving input from user 501. User 501 may use input device 510, without limitation, to select or enter one or more incentives to purchase, to enter credential information, to search for merchants or merchant categories and associated incentives, and the like. Input device 510 may include, for example, a keyboard, a pointing device, a mouse, a stylus, a touch sensitive panel (such as a touch pad or a touch screen), a gyroscope, an accelerometer, a position detector, a biometric input device, or an audio input device. A single component such as a touch screen may function as both an output device of media output component 508 and input device 510.

In one embodiment, user computer device 502 further includes a communication interface 512, communicatively coupled to a remote device such as IRM computing device 102 (shown in FIG. 1). Communication interface 512 may include, for example, a wired or wireless network adapter and/or a wireless data transceiver for use with a mobile telecommunications network.

In the example embodiment, memory area 506 stores computer readable instructions for providing a user interface to user 501 through media output component 508 and, optionally, for receiving and processing input from input device 510. A user interface may include, among other possibilities, a web browser and/or a client application (e.g., account management app 112). Web browsers enable users, such as user 501, to display and interact with media and other information typically embedded on a web page or a website from IRM computing device 102. A client application allows user 501 to interact with, for example, IRM computing device (e.g., account management platform 110). In one example, instructions may be stored by a cloud service, and the output of the execution of the instructions sent to the media output component 508.

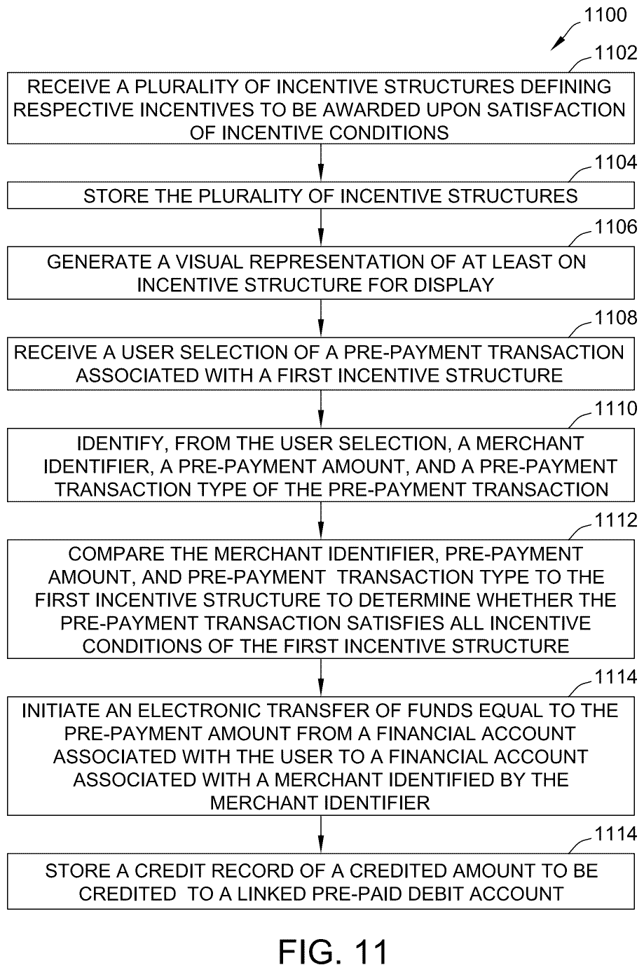

Processor 504 executes computer-executable instructions for implementing aspects of the disclosure. In some embodiments, processor 504 is transformed into a special purpose microprocessor by executing computer-executable instructions or by otherwise being programmed. For example, processor 504 may be programmed with instructions such that it may execute the processes as illustrated in FIG. 11, below.

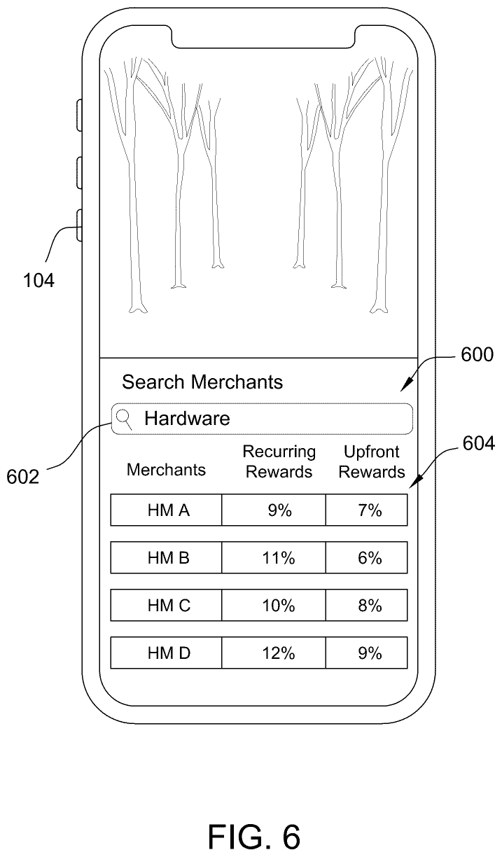

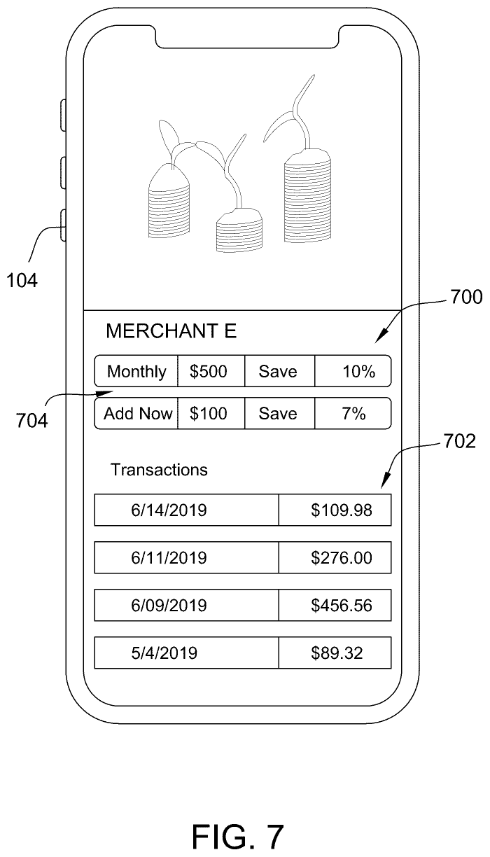

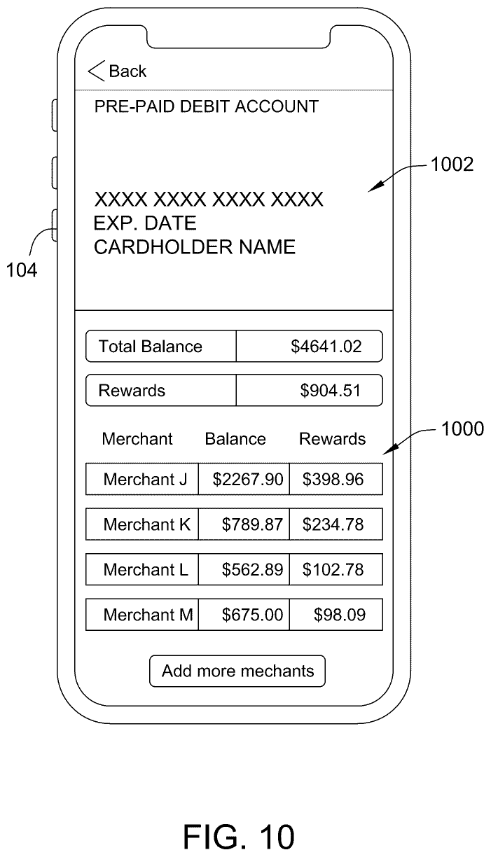

FIGS. 6-10 illustrate various screen-captures of example user interfaces displayed on a user computing device 104 (shown in FIG. 1), in accordance with the present disclosure. More specifically, FIG. 6 depicts a user search inquiry screen-capture 600 within account management app 112 (also shown in FIG. 1), FIGS. 7-9 depict respective screen-captures 700, 800, and 900 of user transaction histories and visual representations of associated incentives, and FIG. 10 depicts a dashboard view screen-capture 1000 including available balances of credited funds in a linked pre-paid debit account, available to use with a plurality of merchants.

Turning to FIG. 6, account management app 112 may enable the user to search various merchants and/or merchant categories. In response to a user search inquiry, IRM computing device 102 retrieves incentives offered by merchants and/or merchant categories matching or associated with the user search inquiry. In the illustrated embodiment, account management app 112 displays a search bar or text entry field 602, in which the user can enter their search query (e.g., a merchant name, category, category code, etc.). In the illustrated example, the user has input a search inquiry of “Hardware.” IRM computing device 102 receives the user search inquiry (“Hardware”) and performs a lookup in database 106 (shown in FIG. 1) to retrieve incentive structures associated with merchants that match the user search inquiry. In the illustrated example, the IRM computing device 102 retrieves from database 106 incentive structures from Hardware Merchant (HM) A, HM B, HM C, and an Associated Merchant (AM) D, representing at least a partial match to the user's search inquiry.

IRM computing device 102 generates respective visual representations 604 of each retrieved incentive structure. In the illustrated embodiment, visual representations 604 include text-based representations of a value of the incentive offered, in this case a percentage of a pre-payment amount. Moreover, visual representations 604 include text-based representations of the difference incentives associated with different pre-payment transaction types (i.e., recurring vs. one-time).

In FIG. 7, IRM computing device 102 has retrieved a transaction history 702 of the user of user computing device 104. Transaction history 702 includes transaction data for a plurality of transactions initiated by the user with a particular merchant (MERCHANT E) over a period of time (e.g., the past six months, the past year, the past two years, etc.). Transaction history 702 may include purchase transactions made by the user using one or more payment accounts and/or payment cards associated therewith. That is, transaction history 702 is not necessarily limited to one payment account and/or payment card.

IRM computing device 102 has identified, based on transaction history 702, that the user regularly or frequently transacts with Merchant E. In this example, the user has transacted with Merchant E four times in six weeks and has spent over $900.00 at Merchant E in that time period. Accordingly, IRM computing device 102 retrieves and displays incentives offered by Merchant E. More specifically, IRM computing device 102 performs a lookup in database 106 using a merchant identifier of Merchant E, and retrieves incentives structures associated with incentives offered by Merchant E. IRM computing device 102 generates visual representations 704 of those incentive structures. In the illustrated embodiment, visual representations 704 include text-based representations of a value of the incentive offered, in this case a percentage of a pre-payment amount, and a pre-payment amount required to receive the incentive. Moreover, visual representations 704 include text-based representations of the difference incentives associated with different pre-payment transaction types (i.e., monthly recurring vs. one-time).

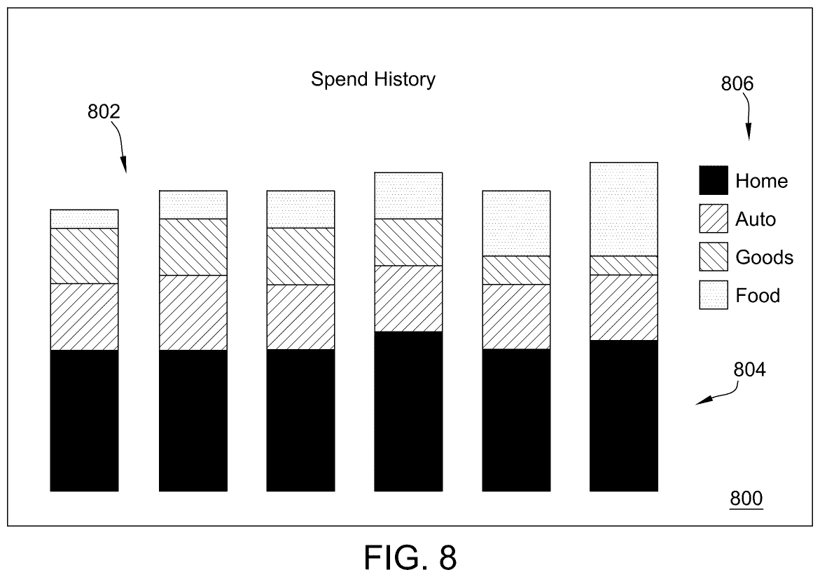

FIG. 8 illustrates a screen-capture 800 with a visual representation 802 of a transaction history 804. Transaction history 804 illustrates a user's spend over time in various merchant categories 806. As described herein, IRM computing device 102 is configured to identify, based on transaction history 804, a subset of merchants with which the user regularly or frequently transacts, and/or merchant categories with frequent or regular user spend.

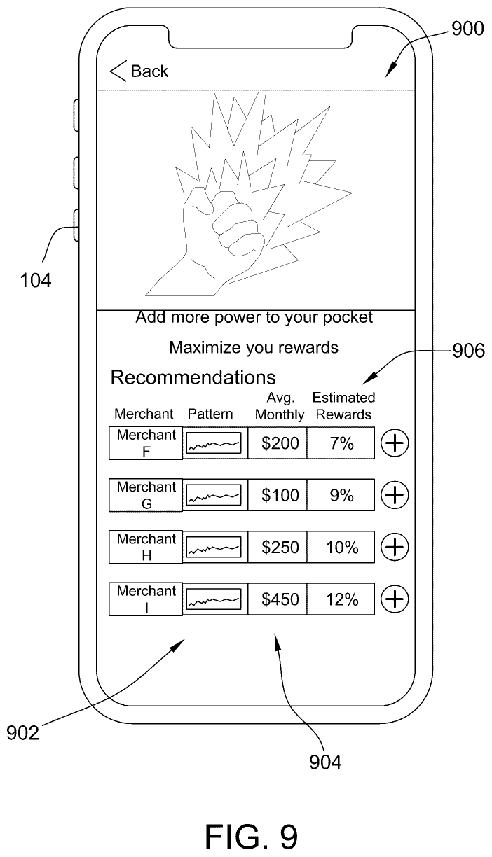

FIG. 9 depicts a transaction history 902 retrieved and analyzed by IRM computing device 102. IRM computing device 102 displays a visual representation of transaction history 902 including line graphs of the user's historical spend at each of merchants Merchant F, Merchant G, Merchant H, and Merchant I (“frequent merchants”).

In this embodiment, IRM computing device 102 has computed or calculated an average monthly spend 904, by the user, at each of the frequent merchants. Based on average monthly spend 904, IRM computing device 102 performs a lookup in database 106 (e.g., using merchant identifiers of the frequent merchants and/or the average monthly spend at each frequent merchant) to identify any incentive(s) offered by these merchants for which the user would be eligible. More specifically, IRM computing device 102 retrieves the maximum incentive offered, by each merchant, based on the average monthly spend 904. IRM computing device 102 generates visual representations (e.g., text-based representations) 906 of these incentives and displays visual representations 906 within account management app 112, to encourage the user to pre-pay the frequent merchants for their average monthly spend in exchange for the incentive.

FIG. 10 is a screen-capture 1000 of a dashboard or home view of account management app 112. The dashboard shows the account credentials 1002 associated with the pre-paid debit account (e.g., a PAN, expiration date, etc. of a virtual and/or physical debit card). The dashboard also displays to the user an available balance of credited funds, and an overall amount of rewards available and/or expended on purchase transactions. The dashboard may further display a balance of credited funds for each merchant that the user has pre-paid, as well as any incentives earned and/or expended with that merchant.

FIG. 11 is a flowchart of a computer-implemented method 1100, which may be implemented using system 100, specifically using IRM computing device 102 (both shown in FIG. 1). In the example embodiment, method 1100 includes receiving 1102, from a plurality of merchant computing devices (e.g., merchant computing devices 114, shown in FIG. 1), a respective plurality of incentive structures (e.g., incentive structures 200, shown in FIG. 2) defining respective incentives to be awarded upon satisfaction of one or more incentive conditions. Method 1100 also includes storing 1104, in a memory (e.g., database 106, shown in FIG. 1), the plurality of incentive structures.

Method 1100 also includes generating 1106 a visual representation of at least one of the plurality of incentive structures for display within a user interface of an account management software application (e.g., account management app 112) stored and executed on a user computing device (e.g., user computing device 104, both shown in FIG. 1) of a user. Method 1100 further includes receiving 1108, from the user computing device, a user selection of a pre-payment transaction associated with a first incentive structure of the plurality of incentive structures. Method 1100 includes identifying 1110, from the user selection, a merchant identifier, a pre-payment amount, and a pre-payment transaction type of the pre-payment transaction, and comparing 1112 the merchant identifier, pre-payment amount, and pre-payment transaction type to the first incentive structure to determine whether the pre-payment transaction satisfies all incentive conditions of the first incentive structure.

In addition, method 1100 includes initiating 1114, when the pre-payment transaction satisfies all incentive conditions of the first incentive structure, an electronic transfer of funds equal to the pre-payment amount from a financial account associated with the user to a financial account associated with a merchant identified by the merchant identifier. Further, method 1100 includes storing 1116, in the memory, a credit record (e.g., credit record 300, shown in FIG. 3) of a credited amount to be credited to a linked pre-paid debit account associated with the user. The credited amount includes the pre-payment amount as well as an incentive amount identified in the first incentive structure. The credit record includes the merchant identifier and control measures limiting withdrawal of funds in the credited amount from the linked pre-paid debit account to transactions initiated with the merchant.

It should be readily understood that method 1100 may include fewer, additional, and/or alternative steps, including those described elsewhere herein. For example, in some embodiments, method 1100 further includes: (i) receiving a transaction authorization request message for a purchase transaction initiated by the user with the merchant, the transaction authorization request message including a merchant identifier of the merchant, a transaction amount, and account identifier of the linked pre-paid debit account, (ii) performing a lookup in the memory using the merchant identifier to retrieve the credit record identifying the credited amount of funds available for withdrawal from the linked pre-paid debit account, and (iii) deducting the transaction amount from the credited amount of funds in the linked pre-paid debit account.

In some such embodiments, method 1100 further includes generating a transaction record associated with the purchase transaction, and storing, in the memory, the transaction record in a memory location associated with the credit record to track withdrawals of the credited amount of funds from the linked pre-paid debit account. In some embodiments, where the financial account associated with the merchant is a holding account maintained at a third-party financial institution, method 1100 further includes transmitting an instruction to the third-party financial institution to transmit funds in a value proportional to the transaction amount from the holding account associated with the merchant to a financial account of the merchant where the funds are available to the merchant.

As described herein, IRM computing device 102 may conduct any number of these pre-payment transactions and generate any number of credit records. Accordingly, in some embodiments, method 1100 further includes receiving, from the user computing device, a second user selection of a second pre-payment transaction associated with a second incentive structure of the plurality of incentive structures. Method 1100 may include identifying, from the second user selection, a second merchant, a second pre-payment amount, and a pre-payment transaction type of the second pre-payment transaction, and comparing the second merchant, second pre-payment amount, and pre-payment transaction type to the second incentive structure to determine whether the second pre-payment transaction satisfies all incentive conditions of the second incentive structure. Method 1100 may also include initiating, when the second pre-payment transaction satisfies all incentive conditions of the second incentive structure, a transfer of funds in the second pre-payment amount from the financial account associated with the user to a financial account associated with the second merchant. Method 1100 may further include storing, in the memory, a second credit record of a second credited amount to be credited to the linked pre-paid debit account associated with the user. The second credited amount includes the second pre-payment amount as well as a second incentive amount identified in the second incentive structure. The second credit record includes an identifier of the second merchant and limits withdrawal of funds in the second credited amount from the linked pre-paid debit account to transactions initiated with the second merchant.

In some embodiments, method 1100 includes retrieving a transaction history for the user for a period of time, the transaction history including transaction data for a plurality of purchase transactions initiated by the user with one or more merchants and using one or more payment accounts over the period of time. Method 1100 may also include identifying, from the transaction data, a subset of the plurality of merchants with which the user regularly transacted over the period of time, and retrieving, from the memory, at least one respective incentive structure for each merchant of the subset of merchants. In such embodiments, generating 1106 includes generating the visual representation including the incentive structures for the subset of merchants for display within the user interface of the account management software app.

In some such embodiments, method 1100 may further include calculating an average monthly spend of the user at each merchant of the subset of merchants, and retrieving, from the memory, the respective incentive structure for each merchant of the subset of merchants for which all incentive conditions would be satisfied based upon the average monthly spend of the user at that merchant. In such embodiments, generating 1106 includes generating the visual representation including the incentive structures for the subset of merchants for which all incentive conditions would be satisfied for display within the user interface of the account management software application.

In some embodiments, when the pre-payment transaction type of the pre-payment transaction is a one-time transaction type, the incentive amount is a first amount, and when the payment transaction type of the pre-payment transaction is a recurring transaction type, the incentive amount is a second amount greater than the first amount.

In some embodiments, when the pre-payment transaction type of the pre-payment transaction is a recurring transaction type, method 1100 may include initiating, after an interval of time indicated in the user selection, a second transfer of funds in the pre-payment amount from the financial account associated with the user to the financial account associated with the merchant. Method 1100 may additionally include updating, in the memory, the credit record with an updated credited amount by adding the pre-payment amount and the incentive amount to any remaining credited amount in the linked pre-paid debit account.

In some embodiments, method 1100 further includes receiving, from the user computing device, a user inquiry including a merchant category, identifying a subset of the plurality of merchants that are associated with the merchant category, and retrieving, from the memory, at least one incentive structure for each of the subset of merchants. In such embodiments, generating 1106 includes generating the visual representation including the incentive structures for the subset of merchants for display.

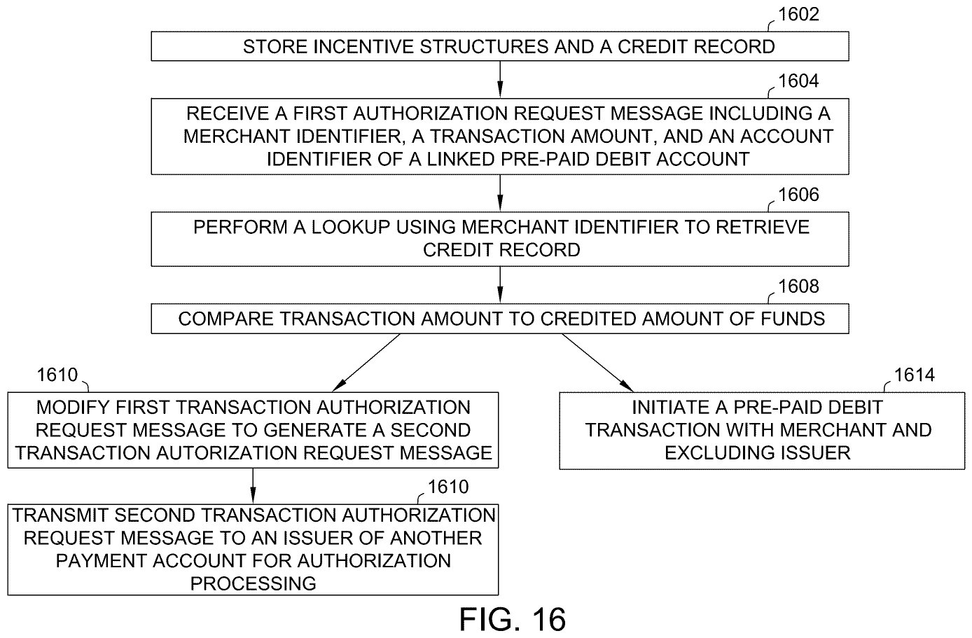

FIG. 16 is a flowchart of a computer-implemented method 1600, which may be implemented using system 100, specifically using IRM computing device 102 (both shown in FIG. 1). In the example embodiment, method 1600 includes storing 1602, in the memory, (i) a plurality of incentive structures associated with a respective plurality of merchants, each incentive structure defining a respective incentive to be awarded upon satisfaction of one or more incentive conditions, and (ii) a credit record of a credited amount to be credited to a linked pre-paid debit account associated with a user, the credited amount including a pre-payment amount of funds pre-paid to a first merchant as well as an incentive amount identified in a first incentive structure, wherein the credit record includes a merchant identifier of the merchant and control measures limiting withdrawal of funds in the credited amount from the linked pre-paid debit account to transactions initiated with the merchant.

Method 1600 also includes receiving 1604 a first transaction authorization request message for a purchase transaction initiated by the user with the merchant, the first transaction authorization request message including the merchant identifier of the merchant, a transaction amount, and account identifier of the linked pre-paid debit account. Method 1600 further includes performing 1606 a lookup in the memory using the merchant identifier to retrieve the credit record identifying the credited amount of funds available for withdrawal from the linked pre-paid debit account, and comparing 1608 the transaction amount to the credited amount of funds.

Method 1600 further includes, when the transaction amount is greater than the credited amount of funds: modifying 1610 the first transaction authorization request message to generate a second transaction authorization request message, and transmitting 1612 the second transaction authorization request message to an issuer of another payment account associated with the user for authorization processing. Method 1600 also includes, when the transaction amount is less than or equal to the credited amount of funds, initiating 1614 a pre-paid debit transaction with the merchant and excluding the issuer.

It should be readily understood that method 1600 may include fewer, additional, and/or alternative steps, including those described elsewhere herein. For example, in some embodiments, modifying 1610 includes replacing the account identifier of the linked pre-paid debit account with an account identifier of the another payment account. In some embodiments, modifying 1610 includes determining an adjusted transaction amount including the total transaction amount less the credited amount of funds, and modifying 1610 the first transaction authorization request message by replacing the transaction amount with the adjusted transaction amount.

In some embodiments, modifying 1610 includes modifying at least one original data element from the first transaction authorization request message to a corresponding at least one modified data element, and appending a flag to the second transaction authorization request message, wherein the flag causes any subsequent authorization response message to be routed from the issuer back to the IRM computing device. In some such embodiments, method 1600 further includes receiving a first transaction authorization response message from the issuer, the first transaction authorization response message including the at least one modified data element and the flag; in response to processing the flag, modifying the first transaction authorization response message to generate a second transaction authorization response message by replacing the at least one modified data element in the first transaction authorization response message with the corresponding at least one original data element; and transmitting the second transaction authorization message to the merchant.

In some embodiments, method 1600 further includes conduct the pre-paid debit transaction by: (i) deducting the transaction amount from the credited amount of funds in the linked pre-paid debit account; and/or (ii) transmitting a substitute transaction authorization response message to the merchant.

While the disclosure has been described in terms of various specific embodiments, those skilled in the art will recognize that particular elements of one drawing in the disclosure can be practice with elements of other drawings herein, or with modification thereto, and without departing from the spirit and/or scope of the claims.

As will be appreciated based on the foregoing specification, the above-discussed embodiments of the disclosure may be implemented using computer programming or engineering techniques including computer software, firmware, hardware or any combination or subset thereof. Any such resulting program, having computer-readable and/or computer-executable instructions, may be embodied or provided within one or more computer-readable media, thereby making a computer program product (that is, an article of manufacture) according to the discussed embodiments of the disclosure. The computer readable media may be, for instance, a fixed (hard) drive, diskette, optical disk, magnetic tape, semiconductor memory such as read-only memory (ROM) or flash memory, etc., or any transmitting/receiving medium such as the Internet or other communication network or link. The article of manufacture containing the computer code may be made and/or used by executing the instructions directly from one medium, by copying the code from one medium to another medium, or by transmitting the code over a network.

As used herein, the term “non-transitory computer-readable media” is intended to be representative of any tangible computer-based device implemented in any method or technology for short-term and long-term storage of information, such as, computer-readable instructions, data structures, program modules and sub-modules, or other data in any device. Therefore, the methods described herein may be encoded as executable instructions embodied in a tangible, non-transitory, computer readable medium, including, without limitation, a storage device and/or a memory device. Such instructions, when executed by a processor, cause the processor to perform at least a portion of the methods described herein. Moreover, as used herein, the term “non-transitory computer-readable media” includes all tangible, computer-readable media, including, without limitation, non-transitory computer storage devices, including, without limitation, volatile and nonvolatile media, and removable and non-removable media such as a firmware, physical and virtual storage, CD-ROMs, DVDs, and any other digital source such as a network or the Internet, as well as yet to be developed digital means, with the sole exception being a transitory, propagating signal.

As used herein, the term “computer” and related terms, such as “computing device,” are not limited to integrated circuits referred to in the art as a computer, but broadly refers to a microcontroller, a microcomputer, a programmable logic controller (PLC), an application specific integrated circuit, and other programmable circuits, and these terms are used interchangeably herein.

Approximating language, as used herein throughout the specification and claims, may be applied to modify any quantitative representation that could permissibly vary without resulting in a change in the basic function to which it is related. Accordingly, a value modified by a term or terms, such as “about” and “substantially”, are not to be limited to the precise value specified. In at least some instances, the approximating language may correspond to the precision of an instrument for measuring the value. Here and throughout the specification and claims, range limitations may be combined and/or interchanged; such ranges are identified and include all the sub-ranges contained therein unless context or language indicates otherwise.

This written description uses examples to disclose the invention, including the best mode, and also to enable any person skilled in the art to practice the embodiments, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. An integrated record management (IRM) computing device comprising at least one memory and at least one processor communicatively coupled to the memory, the at least one processor programmed to:
receive, from a plurality of merchant computing devices, a respective plurality of incentive structures defining respective incentives to be awarded upon satisfaction of one or more incentive conditions;
store, in the at least one memory, the plurality of incentive structures;
generate a visual representation of at least one of the plurality of incentive structures for display within a user interface of an account management software application stored and executed on a user computing device of a user;
receive, from the user computing device, a user selection of a pre-payment transaction associated with a first incentive structure of the plurality of incentive structures;
identify, from the user selection, a merchant identifier, a pre-payment amount, and a pre-payment transaction type of the pre-payment transaction;
compare the merchant identifier, pre-payment amount, and pre-payment transaction type to the first incentive structure to determine whether the pre-payment transaction satisfies all incentive conditions of the first incentive structure;
when the pre-payment transaction satisfies all incentive conditions of the first incentive structure, initiate an electronic transfer of funds equal to the pre-payment amount from a financial account associated with the user to a financial account associated with a merchant identified by the merchant identifier; and
store, in the at least one memory, a credit record of a credited amount to be credited to a linked pre-paid debit account associated with the user, the credited amount including the pre-payment amount as well as an incentive amount identified in the first incentive structure, wherein the credit record includes the merchant identifier and control measures limiting withdrawal of funds in the credited amount from the linked pre-paid debit account to transactions initiated with the merchant.

2. The IRM computing device of claim 1, wherein the at least one processor is further programmed to:
receive a transaction authorization request message for a purchase transaction initiated by the user with the merchant, the transaction authorization request message including the merchant identifier of the merchant, a transaction amount, and account identifier of the linked pre-paid debit account;
perform a lookup in the memory using the merchant identifier to retrieve the credit record identifying the credited amount of funds available for withdrawal from the linked pre-paid debit account; and
deduct the transaction amount from the credited amount of funds in the linked pre-paid debit account.

3. The IRM computing device of claim 2, wherein the at least one processor is further programmed to:
generate a transaction record associated with the purchase transaction; and
store, in the at least one memory, the transaction record in a memory location associated with the credit record to track withdrawals of the credited amount of funds from the linked pre-paid debit account.

4. The IRM computing device of claim 2, wherein the financial account associated with the merchant is a holding account maintained at a third-party financial institution, and wherein the at least one processor is further programmed to:
transmit an instruction to the third-party financial institution to transmit funds in a value proportional to the transaction amount from the holding account associated with the merchant to a financial account of the merchant where the funds are available to the merchant.

5. The IRM computing device of claim 1, wherein the at least one processor is further programmed to:
receive, from the user computing device, a second user selection of a second pre-payment transaction associated with a second incentive structure of the plurality of incentive structures;
identify, from the second user selection, a second merchant identifier, a second pre-payment amount, and a pre-payment transaction type of the second pre-payment transaction;
compare the second merchant identifier, second pre-payment amount, and pre-payment transaction type to the second incentive structure to determine whether the second pre-payment transaction satisfies all incentive conditions of the second incentive structure;
when the second pre-payment transaction satisfies all incentive conditions of the second incentive structure, initiate a transfer of funds in the second pre-payment amount from the financial account associated with the user to a financial account associated with a second merchant identified by the second merchant identifier; and
store, in the at least one memory, a second credit record of a second credited amount to be credited to the linked pre-paid debit account associated with the user, the second credited amount including the second pre-payment amount as well as a second incentive amount identified in the second incentive structure, wherein the second credit record includes the second merchant identifier and limits withdrawal of funds in the second credited amount from the linked pre-paid debit account to transactions initiated with the second merchant.

6. The IRM computing device of claim 1, wherein the at least one processor is further programmed to:
retrieve a transaction history for the user for a period of time, the transaction history including transaction data for a plurality of purchase transactions initiated by the user with one or more merchants and using one or more payment accounts over the period of time;
identify, from the transaction data, a subset of the plurality of merchants with which the user regularly transacted over the period of time;
retrieve, from the at least one memory, at least one respective incentive structure for each merchant of the subset of merchants; and
generate the visual representation including the incentive structures for the subset of merchants for display within the user interface of the account management software application.

7. The IRM computing device of claim 6, wherein the at least one processor is further programmed to:
calculate an average monthly spend of the user at each merchant of the subset of merchants;
retrieve, from the at least one memory, the respective incentive structure for each merchant of the subset of merchants for which all incentive conditions would be satisfied based upon the average monthly spend of the user at that merchant; and
generate the visual representation including the incentive structures for the subset of merchants for which all incentive conditions would be satisfied for display within the user interface of the account management software application.

8. The IRM computing device of claim 1, wherein, when the pre-payment transaction type of the pre-payment transaction is a one-time transaction type, the incentive amount is a first amount, and when the pre-payment transaction type of the pre-payment transaction is a recurring transaction type, the incentive amount is a second amount greater than the first amount.

9. The IRM computing device of claim 1, wherein, when the pre-payment transaction type of the pre-payment transaction is a recurring transaction type, the at least one processor is further programmed to:
automatically initiate, after an interval of time indicated in the user selection, a second transfer of funds in the pre-payment amount from the financial account associated with the user to the financial account associated with the merchant; and
update, in the at least one memory, the credit record with an updated credited amount by adding the pre-payment amount and the incentive amount to any remaining credited amount in the linked pre-paid debit account.

10. The IRM computing device of claim 1, wherein the at least one processor is further programmed to:
receive, from the user computing device, a user inquiry including a merchant category;
identify a subset of the plurality of merchants that are associated with the merchant category;
retrieve, from the at least one memory, at least one incentive structure for each of the subset of merchants; and
generate the visual representation including the incentive structures for the subset of merchants for display.

11. A computer-implemented method implemented using an integrated record management (IRM) computing device including at least one memory and at least one processor communicatively coupled to the at least one memory, the method comprising:
receiving, from a plurality of merchant computing devices, a respective plurality of incentive structures defining respective incentives to be awarded upon satisfaction of one or more incentive conditions;
storing, in the at least one memory, the plurality of incentive structures;
generating a visual representation of at least one of the plurality of incentive structures for display within a user interface of an account management software application stored and executed on a user computing device of a user;
receiving, from the user computing device, a user selection of a pre-payment transaction associated with a first incentive structure of the plurality of incentive structures;
identifying, from the user selection, a merchant identifier, a pre-payment amount, and a pre-payment transaction type of the pre-payment transaction;
comparing the merchant identifier, pre-payment amount, and pre-payment transaction type to the first incentive structure to determine whether the pre-payment transaction satisfies all incentive conditions of the first incentive structure:
when the pre-payment transaction satisfies all incentive conditions of the first incentive structure, initiating an electronic transfer of funds equal to the pre-payment amount from a financial account associated with the user to a financial account associated with a merchant identified by the merchant identifier; and
storing, in the at least one memory, a credit record of a credited amount to be credited to a linked pre-paid debit account associated with the user, the credited amount including the pre-payment amount as well as an incentive amount identified in the first incentive structure, wherein the credit record includes the merchant identifier and control measures limiting withdrawal of funds in the credited amount from the linked pre-paid debit account to transactions initiated with the merchant.

12. The method of claim 11, further comprising:
receiving a transaction authorization request message for a purchase transaction initiated by the user with the merchant, the transaction authorization request message including the merchant identifier of the merchant, a transaction amount, and account identifier of the linked pre-paid debit account;
performing a lookup in the at least one memory using the merchant identifier to retrieve the credit record identifying the credited amount of funds available for withdrawal from the linked pre-paid debit account; and
deducting the transaction amount from the credited amount of funds in the linked pre-paid debit account.

13. The method of claim 12, further comprising:
generating a transaction record associated with the purchase transaction; and
storing, in the at least one memory, the transaction record in a memory location associated with the credit record to track withdrawals of the credited amount of funds from the linked pre-paid debit account.

14. The method of claim 12, wherein the financial account associated with the merchant is a holding account maintained at a third-party financial institution, and wherein the method further comprising:
transmitting an instruction to the third-party financial institution to transmit funds in a value proportional to the transaction amount from the holding account associated with the merchant to a financial account of the merchant where the funds are available to the merchant.

15. The method of claim 11, further comprising:
receiving, from the user computing device, a second user selection of a second pre-payment transaction associated with a second incentive structure of the plurality of incentive structures;
identifying, from the second user selection, a second merchant identifier, a second pre-payment amount, and a pre-payment transaction type of the second pre-payment transaction;
comparing the second merchant identifier, second pre-payment amount, and pre-payment transaction type to the second incentive structure to determine whether the second pre-payment transaction satisfies all incentive conditions of the second incentive structure;
when the second pre-payment transaction satisfies all incentive conditions of the second incentive structure, initiating a transfer of funds in the second pre-payment amount from the financial account associated with the user to a financial account associated with a second merchant identified by the second merchant identifier; and
storing, in the at least one memory, a second credit record of a second credited amount to be credited to the linked pre-paid debit account associated with the user, the second credited amount including the second pre-payment amount as well as a second incentive amount identified in the second incentive structure, wherein the second credit record includes the second merchant identifier and limits withdrawal of funds in the second credited amount from the linked pre-paid debit account to transactions initiated with the second merchant.

16. The method of claim 11, further comprising:
retrieving a transaction history for the user for a period of time, the transaction history including transaction data for a plurality of purchase transactions initiated by the user with one or more merchants and using one or more payment accounts over the period of time;
identifying, from the transaction data, a subset of the plurality of merchants with which the user regularly transacted over the period of time;
retrieving, from the at least one memory, at least one respective incentive structure for each merchant of the subset of merchants; and
generating the visual representation including the incentive structures for the subset of merchants for display within the user interface of the account management software application.

17. The method of claim 16, further comprising:
calculating an average monthly spend of the user at each merchant of the subset of merchants;
retrieving, from the at least one memory, the respective incentive structure for each merchant of the subset of merchants for which all incentive conditions would be satisfied based upon the average monthly spend of the user at that merchant; and
generating the visual representation including the incentive structures for the subset of merchants for which all incentive conditions would be satisfied for display within the user interface of the account management software application.

18. The method of claim 11, wherein, when the pre-payment transaction type of the pre-payment transaction is a recurring transaction type, the method further comprises:
automatically initiating, after an interval of time indicated in the user selection, a second transfer of funds in the pre-payment amount from the financial account associated with the user to the financial account associated with the merchant; and
updating, in the at least one memory, the credit record with an updated credited amount by adding the pre-payment amount and the incentive amount to any remaining credited amount in the linked pre-paid debit account.

19. The method of claim 11, further comprising:
receiving, from the user computing device, a user inquiry including a merchant category;
identifying a subset of the plurality of merchants that are associated with the merchant category;
retrieving, from the at least one memory, at least one incentive structure for each of the subset of merchants; and
generating the visual representation including the incentive structures for the subset of merchants for display.

20. At least one non-transitory computer-readable storage medium having stored thereon computer-executable instructions that, when executed by at least one processor, cause the at least one processor to:
receive, from a plurality of merchant computing devices, a respective plurality of incentive structures defining respective incentives to be awarded upon satisfaction of one or more incentive conditions;
store, in the at least one memory, the plurality of incentive structures;
generate a visual representation of at least one of the plurality of incentive structures for display within a user interface of an account management software application stored and executed on a user computing device of a user;
receive, from the user computing device, a user selection of a pre-payment transaction associated with a first incentive structure of the plurality of incentive structures;
identify, from the user selection, a merchant identifier, a pre-payment amount, and a pre-payment transaction type of the pre-payment transaction;
compare the merchant identifier, pre-payment amount, and pre-payment transaction type to the first incentive structure to determine whether the pre-payment transaction satisfies all incentive conditions of the first incentive structure;
when the pre-payment transaction satisfies all incentive conditions of the first incentive structure, initiate an electronic transfer of funds equal to the pre-payment amount from a financial account associated with the user to a financial account associated with a merchant identified by the merchant identifier; and
store, in the at least one memory, a credit record of a credited amount to be credited to a linked pre-paid debit account associated with the user, the credited amount including the pre-payment amount as well as an incentive amount identified in the first incentive structure, wherein the credit record includes the merchant identifier and control measures limiting withdrawal of funds in the credited amount from the linked pre-paid debit account to transactions initiated with the merchant.
